(19) United States
(12) Patent Application Publication
(10) Pub. No.: US 2025/0139623 A1
(43) Pub. Date: May 1, 2025

(54) DEVICE AND METHOD OF DEVICE DISCOVERY FOR TRANSACTIONS AMONG CLIENT DEVICES BASED ON A LOCAL TRANSACTION ARCHITECTURE

(71) Applicant: INTERAC CORP., Toronto (CA)

(72) Inventor: Jordan William CROMBIE, Toronto (CA)

(21) Appl. No.: 18/496,617

(22) Filed: Oct. 27, 2023

(51) Int. Cl. G06Q 20/40; G06Q 20/32

(52) U.S. Cl. CPC G06Q 20/4014; G06Q 20/3224

(57) ABSTRACT

A device comprising a communication circuit; a processor, and a memory coupled to the processor. The memory stores processor-executable instructions that configure the processor to: receive verification of a signed transaction coordinator authentication token, the received verification comprising initialization data including a first proxy user discovery identifier associated with a user transaction identifier and a first alias identifier; receive input representing a request to alter the first alias identifier to a second alias identifier; transmit a signal representing the request to alter the first alias identifier; receive, from the transaction coordinator system, a second proxy user discovery identifier associated with the user transaction identifier and the second alias identifier for the downstream short-range transfer data process; and communicate a discovery packet via a short-range network, the discovery packet including the second proxy user discovery identifier and a data flag indicating that the discovery packet includes discovery data.

### FIELD

Embodiments of the present disclosure generally relate to the field of computing device discovery systems and, in particular, to devices and methods of device discovery for transactions among client devices based on a local transaction architecture.

### BACKGROUND

Electronic payment transaction platforms may be configured for transferring assets among user accounts associated with user computing devices. In some examples, assets may include currency, tokens, precious metals, among other example resources. In some scenarios, operations of a transaction platform may include features of providing electronic instructions to transfer assets among user accounts.

### SUMMARY

The present disclosure describes embodiments of computing devices, systems, and methods of device discovery for transactions among client devices based on a local transaction architecture.

Embodiments of the present disclosure are directed to a short-range transfer systems configured for transient-type electronic payment transactions, such as cash-like transactions, among users associated with computing devices that are proximally located with other computing devices.

To conduct such types of transient-type electronic payment transactions whilst reducing the quantity of personally identifiable or persistent data to be shared among users of computing devices, embodiments of a transaction coordinator system may be configured to generate and map proxy user discovery identifiers for associating with user transaction identifiers on a session-by-session or time-limited basis.

Prior to generating short-range transaction data sets for promulgating electronic payment transactions, respective computing devices may transmit user transaction identifier requests to the transaction coordinator system for verifying that respective proxy user discovery identifiers continue to be timely and valid. User transaction identifiers may be associated with user accounts of banking institutions.

Features of embodiments of these devices, systems, and methods will be further disclosed herein.

In one aspect, the present disclosure provides a method comprising: receiving an invocation of a short-range data process; transmitting, to an account server, a request for a transaction coordinator authentication token; receiving, from the account server, a signed transaction coordinator authentication token including a user transaction identifier associated with a user account at the account server; transmitting, to a transaction coordinator system, the signed transaction coordinator authentication token; receiving verification of the signed transaction coordinator token, the received verification comprising initialization data including a proxy user discovery identifier associated with the user transaction identifier and an alias identifier for a downstream short-range transfer among proximally located devices; and communicating a discovery packet via a short-range network, the discovery packet including the proxy user discovery identifier and a data flag indicating that the discovery packet includes discovery data for the downstream short-range transfer.

In another aspect, the present disclosure provides a device comprising a communication circuit, a processor coupled to the communication circuit, and a memory coupled to the processor. The memory may store processor-executable instructions that, when executed, configure the processor to: receive an invocation of a short-range data process; transmit, to an account server, a request for a transaction coordinator authentication token; receive, from the account server, a signed transaction coordinator authentication token including a user transaction identifier associated with a user account at the account server; transmit, to a transaction coordinator system, the signed transaction coordinator authentication token; receive verification of the signed transaction coordinator token, the received verification comprising initialization data including a proxy user discovery identifier associated with the user transaction identifier and an alias identifier for a downstream short-range transfer among proximally located devices; and communicate a discovery packet via a short-range network, the discovery packet including the proxy user discovery identifier and a data flag indicating that the discovery packet includes discovery data for the downstream short-range transfer.

In another aspect, the present disclosure provides a method comprising: receiving, from a transaction coordinator system, verification of a signed transaction coordinator authentication token, the received verification comprising initialization data including a first proxy user discovery identifier associated with a user transaction identifier and a first alias identifier for a downstream short-range transfer data process among proximally located devices; receiving input representing a request to alter the first alias identifier to a second alias identifier; transmitting, to the transaction coordinator system, a signal representing the request to alter the first alias identifier; receiving, from the transaction coordinator system, a second proxy user discovery identifier associated with the user transaction identifier and the second alias identifier for the downstream short-range transfer data process; and communicating a discovery packet via a short-range network, the discovery packet including the second proxy user discovery identifier and a data flag indicating that the discovery packet includes discovery data for the downstream short-range transfer.

In another aspect, the present disclosure provides a device comprising: a communication circuit, a processor coupled to the communication circuit, and a memory coupled to the processor. The memory may store processor-executable instructions that, when executed, configure the processor to: receive, from a transaction coordinator system, verification of a signed transaction coordinator authentication token, the received verification comprising initialization data including a first proxy user discovery identifier associated with a user transaction identifier and a first alias identifier for a downstream short-range transfer data process among proximally located devices; receive input representing a request to alter the first alias identifier to a second alias identifier; transmit, to the transaction coordinator system, a signal representing the request to alter the first alias identifier; receive, from the transaction coordinator system, a second proxy user discovery identifier associated with the user transaction identifier and the second alias identifier for the downstream short-range transfer data process; and communicate a discovery packet via a short-range network, the discovery packet including the second proxy user discovery identifier and a data flag indicating that the discovery packet includes discovery data for the downstream short-range transfer.

In another aspect, a non-transitory computer-readable medium or media having stored thereon machine interpretable instructions which, when executed by a processor may cause the processor to perform one or more methods described herein.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a short-range transfer system, in accordance with embodiments of the present disclosure;

FIG. 2 illustrates a computing device, in accordance with embodiments of the present disclosure;

FIGS. 3 to 9 illustrate operations of initialization and discovery for short-range transaction operations, in accordance with embodiments of the present disclosure;

FIGS. 10 to 14 illustrate a method of short-range electronic transactions among discovered computing devices physically proximal other computing devices, in accordance with embodiments of the present disclosure;

FIGS. 15 to 17 illustrate a sequence of operations of a short-range electronic transaction, in accordance with embodiments of the present disclosure;

FIGS. 18 to 20 illustrate a sequence of operations of a short-range electronic transaction, in accordance with embodiments of the present disclosure;

FIG. 21 illustrates operations of a short-range transfer system for initialization and discovery of computing devices, in accordance with embodiments of the present disclosure;

FIG. 22 illustrates operations of a short-range system where a sender device operates as an initiating transfer device, in accordance with embodiments of the present disclosure;

FIG. 23 illustrates operations of a short-range system where a recipient device operates as an initiating transfer device, in accordance with embodiments of the present disclosure;

FIG. 24 illustrates a user interface associated with a transaction application, in accordance with embodiments of the present disclosure;

FIG. 25 illustrates a user interface associated with a short-range transfer application, in accordance with embodiments of the present disclosure;

FIG. 26 illustrates a user interface associated with a short-range transfer application, in accordance with embodiments of the present disclosure;

FIG. 27 illustrates a user interface associated with a short-range transfer application, in accordance with embodiments of the present disclosure;

FIG. 28 illustrates a user interface associated with a short-range transfer application, in accordance with embodiments of the present disclosure;

FIG. 29 illustrates a user interface associated with a short-range transfer application, in accordance with embodiments of the present disclosure;

FIG. 30 illustrates a user interface associated with a short-range transfer application, in accordance with embodiments of the present disclosure;

FIG. 31 illustrates a user interface associated with a short-range transfer application, in accordance with embodiments of the present disclosure;

FIG. 32 illustrates a user interface associated with a short-range transfer application, in accordance with embodiments of the present disclosure;

FIG. 33 illustrates a user interface associated with a short-range transfer application, in accordance with embodiments of the present disclosure;

FIG. 34 illustrates a flowchart of a method of short-range transfers, in accordance with embodiments of the present disclosure; and

FIG. 35 illustrates a flowchart of a method of short-range transfers, in accordance with embodiments of the present disclosure.

### DETAILED DESCRIPTION

Embodiments of computing devices, systems, and methods of device discovery for transactions are described in the present disclosure.

One-off transactions, such as cash-type transactions, may be desirable at retail marketplaces, such as farmers' marketplaces, or in situations where vendors provide non-recurring services (e.g., food delivery, among similar examples). Embodiments of the present disclosure may include features to generate transaction requests among computing devices without a requirement to exchange identifiers or other information generally considered personally identifiable information. For instance, in scenarios where users may desire to conduct one-off resource transfers (e.g., akin to conducting cash payment transactions) with no contemplated future resource transfer relationship, sender and recipient users may prefer to not share identifiers that may be generally considered personally identifiable information. Other example scenarios may be contemplated.

In some scenarios, it may be desirable to generate transaction requests among computing devices whilst an associated sender user and a recipient user are in physical proximity of one another. In these example scenarios, a sender user may have additional peace of mind associated with ensuring they are conducting transactions with a party verified by a recipient user's physical presence. Embodiments of the present disclosure may include devices of a local transaction architecture for a sender device to conduct transient-type transactions with recipient devices. Transient-type transactions may correspond with non-recurring interactions among device users lasting for a short duration of time.

Embodiments of the local transaction architecture may provide short-range transaction operations and may be combined with transaction platform operations. Embodiments of the local transaction architecture may be agnostic to the underlying transaction platform configured for transferring assets among user accounts associated with corresponding user computing devices. Example resource transfer platforms may include e-transfer platforms, real-time rail systems, or monetary or resource exchange networks. In some embodiments, asset transactions may include transactions for transferring currency, tokens, or precious metals, among other example assets.

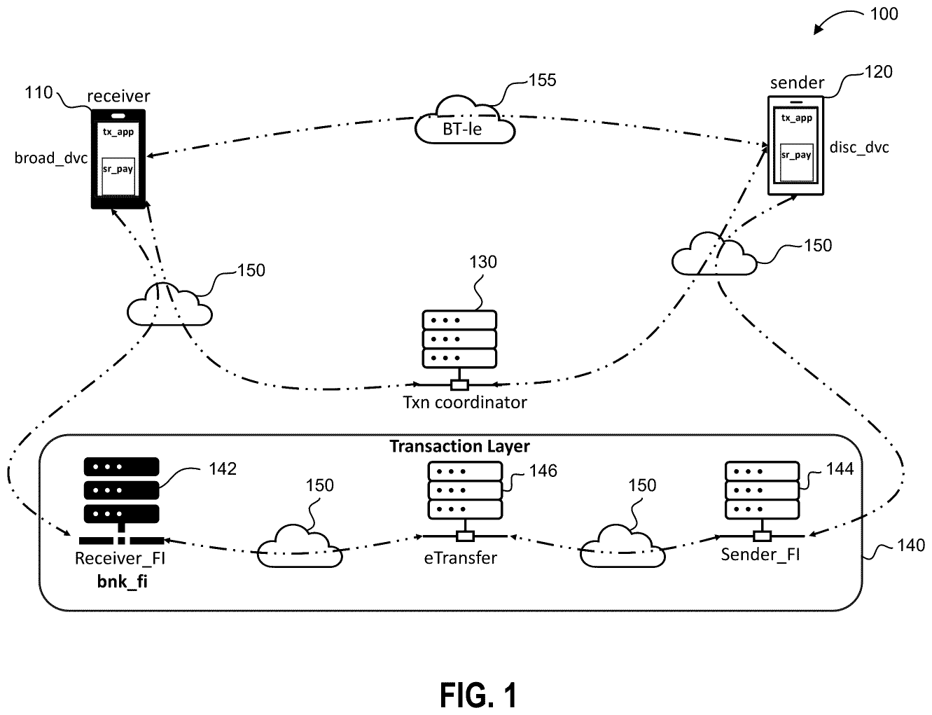

Reference is made to FIG. 1, which illustrates a short-range transfer system 100, in accordance with embodiments of the present disclosure. The short-range transfer system 100 may include one or more computing devices identified with reference numerals 110 and 120. The computing devices may be configured as a broadcasting device or a discovering device depending upon the mode of computing device operation.

As an example, in FIG. 1, the broadcasting device 110 may be configured to initiate discovery operations including operations for broadcasting signals indicating its availability to conduct a short-range transfer. In some embodiments, the short-range transfer operations may be operations among computing devices physically proximal to one another, and the transfer may be a transfer of assets, such as currency, tokens, or other assets, among respective users associated with the computing devices. In the present disclosure, assets may also be referred to as resources.

In some embodiments, when a computing device is operating in a mode as a broadcasting device 110, the computing device may be a recipient of a proposed resource transfer.

In FIG. 1, the discovery device 120 may be configured to detect initiation of discovery operations by the broadcasting device 110. The discovery device 120 may be configured to generate signals to identify itself to the broadcasting device 110 that it may be a counterpart transfer device.

In FIG. 1, a sole discovery device 120 is illustrated. However, in some embodiments, the short-range transfer system 100 may include two or more discovery devices 120 as counterpart transfer devices to the broadcasting device 110.

The broadcasting device 110 and the discovery device 120 may conduct similar operations, and references to the computing device as a broadcasting device 110 or the discovery device 120 are for ease of exposition when operating in a particular mode of computing device operation. For example, any one of the broadcasting device 110 and the discovery device 120 may initiate short-range transfer operations with one or more other devices and thereby become an ‘initiating transfer device’.

In a first resource transfer mode, a computing device (e.g., as a recipient device) operating as an initiating transfer device may request for receipt of assets from at least one other computing device (e.g., sender device). Embodiments will be described herein.

In another resource transfer mode, a computing device (e.g., as a sender device) operating as an initiating transfer device may request sending of assets to at least one other computing device (e.g., recipient device). Embodiments will be described herein.

In some scenarios, when a computing device is configured with operations associated with receiving assets, it may be operating as a recipient device. In some scenarios, when a computing device is configured with operations associated with sending assets, it may be operating as a sender device.

The broadcasting device 110 and the discovery device 120 may be counterpart transfer devices. When in physical proximity of one another, the broadcasting device 110 and the discover device 120 may be configured to conduct operations of transient-type asset transfers, such as cash-like transfers among users associated with the computing devices while minimizing exchange of identifiers that may be considered personally identifiable information.

In some embodiments, computing devices, such as the broadcasting device 110 and the discovery device 120, may be configured to detect or discover other proximally positioned computing devices based on short-range communication protocol messaging, such as Bluetooth™ low energy protocol messages, near-field communication protocol messages, or other types of short-range communication protocol messaging. A maximum physical proximity between the broadcasting device 110 and the discovery device 120 for short-range communication protocol messaging may be defined based on signal strength specifications of respective specific short-range communication protocols.

In some embodiments, the broadcasting device 110 and the discovery device 120 may detect or broadcast messages via a short-range network 155. In some embodiments, the short-range network 155 may be a Bluetooth™ low energy network, a near-field communication network, or other short-distance type communication networks.

The short-range transfer system 100 may include or may communicate with a transaction layer 140. In some embodiments, the short-range transfer system 100 may be agnostic to the type or configuration of the transaction layer 140 for transferring assets among user accounts associated with corresponding user computing devices. For example, the short-range transfer system 100 may be configured to communicate with one or more examples of the transaction layer 140, such as an e-Transfer system, real-time rail systems, or other monetary or resource exchange networks. In some embodiments, the short-range transfer system 100 may configure communication message payloads to communicate with the transaction layer 140 based on the type or configuration of the transaction layer 140, but otherwise is agnostic to the type or configuration of the transaction layer 140.

The transaction layer 140 may include a transaction layer platform 146 for facilitating resource transfer instructions among resource systems 142, 144. The resource systems 142, 144 may be banking institution systems where users of the receiver device or the sender device may have resource accounts or banking accounts thereon. In the example illustrated in FIG. 1, a recipient banking institution system 142 may be associated with a user of the broadcasting device 110 (operating as a recipient device) and a sender banking institution system 144 may be associated with a user of the discovery device 120 (operating as a sender device).

In some embodiments, the transaction layer platform 146 may be an e-Transfer platform, a real-time rail platform, or monetary or resource exchange network platforms. The transaction layer platform 146 may be configured for liaising among the resource systems 142, 144 for transferring assets among user accounts associated with the broadcasting device 110 and the discovery device 120.

The short-range transfer system 100 may include a transaction coordinator system 130. The transaction coordinator 130 may be an application-specific computing platform configured to provide one or more features of the short-range transfer system 100. In some embodiments, operations of the transaction coordinator system 130 may be configured with and be agnostic to the type of underlying transaction layer platform 146 or other implementation details of the transaction layer 140.

The transaction coordinator system 130 may be a back-end platform supporting device discovery or device broadcasting operations for resource transfer operations. Details of the transaction coordinator system 130 will be disclosed herein.

Computing devices, including the broadcasting device 110, the discovery device 120, the transaction coordinator system 130, or platforms of the transaction layer 140 may transmit or receive messages with other devices via a communication network 150. For ease of exposition, the communication network 150 is illustrated as discrete network components between various computing devices; however, the communication network 150 may comprise a combination of the several discrete network components between various computing devices.

In some embodiments, the communication network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks.

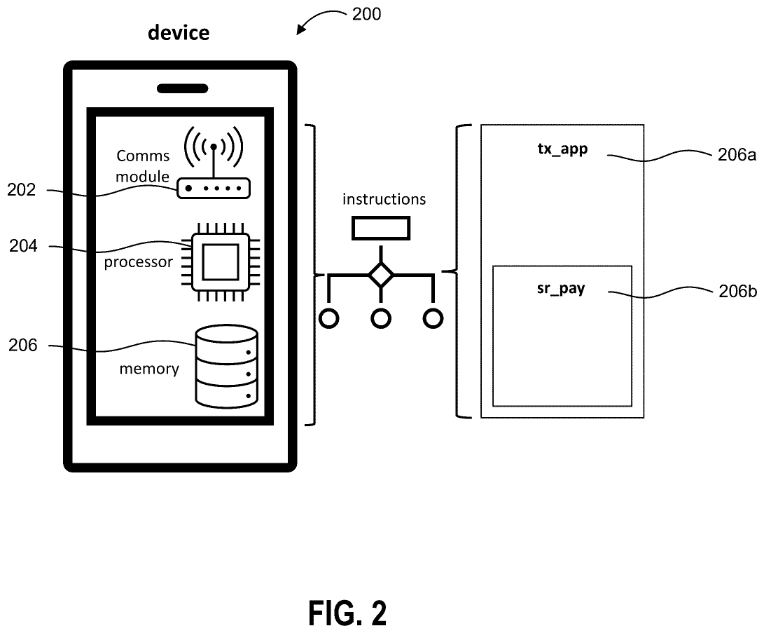

Reference is made to FIG. 2, which illustrates a computing device 200, in accordance with embodiments of the present disclosure. The computing device 200 may operate in different asset transfer modes.

In an embodiment of a first resource transfer mode, the computing device 200 may operate as an initiating transfer device for requesting resources from at least one other computing device (e.g., a sender device). As an example scenario, a recipient user (such as a vendor) at a farmer's market may wish to request monetary payment from a sender user (such as a buyer). The recipient user may have determined a monetary price (e.g., $10) in exchange for goods, and may operate the computing device 200 as an initiating transfer device for requesting $10 for a bundle of vegetables.

In an embodiment of a second resource transfer mode, the computing device 200 may operate as an initiating transfer device for initiating sending of resources to at least one other computing device (e.g., recipient device). As an example scenario, the computing device 200 may be associated with a buyer at a farmer's market and the buyer may wish to transfer a quantity of money to a vendor in exchange for services. The buyer user may determine a monetary price (e.g., $25) in exchange for the example services, and may operate the computing device 200 as an initiating transfer device for requesting sending of $25 for a shoe polish service.

The computing device 200 may be a mobile device, such as a smartphone device, a tablet device, among other example mobile devices. The computing device 200 may include a communication module 202 or a communication circuit configured to transmit or receive data messages to or from other computing devices, to access or connect to network resources, or to perform other computing applications by connecting to a network (or multiple networks) capable of carrying data.

In some embodiments, the communication module 202 may be configurable to transmit or receive data messages across two or more types of networks. Referring again to FIG. 1, the communication module 202 may be configured to transmit or receive data messages across the communication network 150. Further, the communication module 202 may be configured to transmit or receive data messages across the short-range network 155. Transmission or reception of data messages across the short-range network 155 may include data messages associated with short-range discovery operations of embodiments of the short-range transfer system 100 described herein. In some embodiments, the communication module 202 may include a combination of two or more communication circuits based on various network communication protocols.

For example, the communication module 202 may be configured to transmit or receive messages based on the Bluetooth™ low energy protocol via the short-range network 155 (FIG. 1) when interacting with another computing device via short-range communication protocol messaging. The communication module 202 may additionally be configured to transmit or receive message based on a protocol corresponding to the network 150 (FIG. 1). Other combinations of communication protocols may be used.

The computing device 200 may include a memory 206. The memory 206 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 206 may be storage media, such as hard disk drives, solid state drives, optical drives, or other types of memory.

The memory 206 may store processor-readable instructions that when executed conduct operations of a transaction application 206a. For example, the transaction application 206a may be a banking application associated with a resource system 142, 144 (such as a banking institution system). The transaction application 206a may include operations for transmitting and receiving data messages with the banking institution system for managing a user account associated with the computing device 200.

In some embodiments, the transaction application 206a may be configured to manage assets associated with a user account, such as monetary assets of a banking account. In some embodiments, the transaction application 206a may include operations for transmitting a resource transfer instruction set to the resource system 142, 144 for downstream operations for liaising resource transfers among two or more resource systems 142, 144.

In some embodiments, the memory 206 may store processor-readable instructions that when executed conduct operations of a short-range transfer application 206b. In some embodiments, the short-range transfer application 206b may be a standalone application with processor-readable instructions that when executed conduct operations in combination with the transaction application 206a. In some embodiments, the short-range transfer application 206b may be an integral component that is combined with instructions the transaction application 206a.

The short-range transfer application 206b may include instructions that when executed are in combination with instructions of the transaction 206a for transactions among user accounts. In some embodiments, the short-range transfer application 206b may include operations for detection or discovery of other computing devices within a physical proximity of the computing device 200. In some embodiments, the computing device 200 may be configured to detect or discover other proximally positioned computing devices based on short-range communication protocols, such as Bluetooth™ low energy protocols, near-field communication protocols, or image detection operations for identifying graphical indicia such as quick-response (QR) codes.

As will be described herein, in embodiments where Bluetooth™ operations may be used, the short-range transfer application 206b may include instructions to transmit or broadcast a proxy user discovery identifier and to detect proxy user discovery identifiers of other computing devices physically within a proximal geographical location of the computing device 200.

In embodiments where near-field communication operations may be used, the short-range transfer application 206b may include instructions to detect near-field communication (NFC) transmitter signals representing proxy user discovery identifiers of other computing devices physically within a proximal geographical location of the computing device 200.

In embodiments where image detection operations may be used, the short-range transfer application 206b may include instructions to identify QR codes representing proxy user discovery identifiers of other computing devices physically within a proximal geographical location of the computing device 200.

In response to detecting proxy user discovery identifiers of other computing devices within a proximal geographical location of the computing device 200, the short-range transfer application 206b may include instructions for transmitting the detected one or more proxy user discovery identifiers to the transaction coordinator system 130 for correlating the proxy user discovery identifiers with other identifiers or details, such as aliases, representative photos, among other details, to facilitate downstream transaction operations among the computing devices.

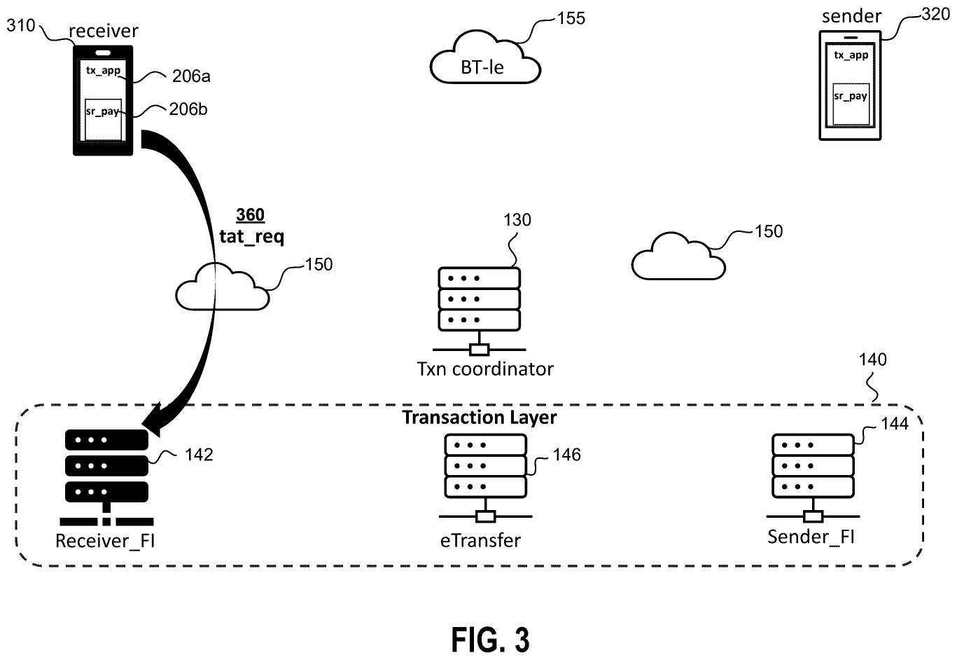

Reference is made to FIGS. 3 to 9, which illustrate operations of initialization and discovery for short-range transaction operations, in accordance with embodiments of the present disclosure. The initialization or discovery operations for short-range transfer operations may be conducted by both sender devices or recipient devices. FIGS. 3 to 9 illustrate operations from a perspective of a recipient device 310; however, embodiments of operations for initialization and discovery may also be conducted from a perspective at a sender device 310.

The recipient device 310 may include a memory storing instructions of the transaction application 206a, such as a banking application, and the short-range transfer application 206b described with reference to FIG. 2. The transaction application 206a may include instructions for operations to enable access to a user's resource or banking account a resource system 142, 144. The transaction application 206a may include operations configured to enable a user to conduct a resource transfer, such as an e-transfer of monetary funds between the user of the recipient device 310 and the sender device 320. In some embodiments, the transfer of monetary funds may be conducted based on operations of the transaction layer 140. The transaction layer 140 may be the Interac™ e-Transfer platform, real-time rail transfer systems, or other resource exchange networks.

In some embodiments, the recipient device 310 may include a display device for displaying user interfaces of the transaction application 206a or the short-range transfer application 206b. The transaction application 206a may include instructions for generating a user authentication user interface, including input fields for receiving a bank application user identifier or a bank application user password, a user identifier (e.g., a user alias), an account number, or other identifier. In some embodiments, the bank application user password may be in the form of alphanumeric text, a biometric input, or other form of user-specific password.

Upon authenticating a user, the transaction application 206a in combination with the short-range transfer application 206b may include instructions to display a short-range user interface element for initializing components of short-range resource transfer operations. For example, the recipient device 310 may receive an invocation of the short-range transfer application 206b.

In response to detecting input at the short-range user interface element, the transaction application 206a includes operations for generating and transmitting, to the resource system 142 associated with a user account of the recipient device 310, a signal representing a transaction authentication token request 360. The request 360 may include a query to provide a transaction coordinator authentication token from the resource system 142. The resource system 142 may be a banking institution server providing an asset account for a user.

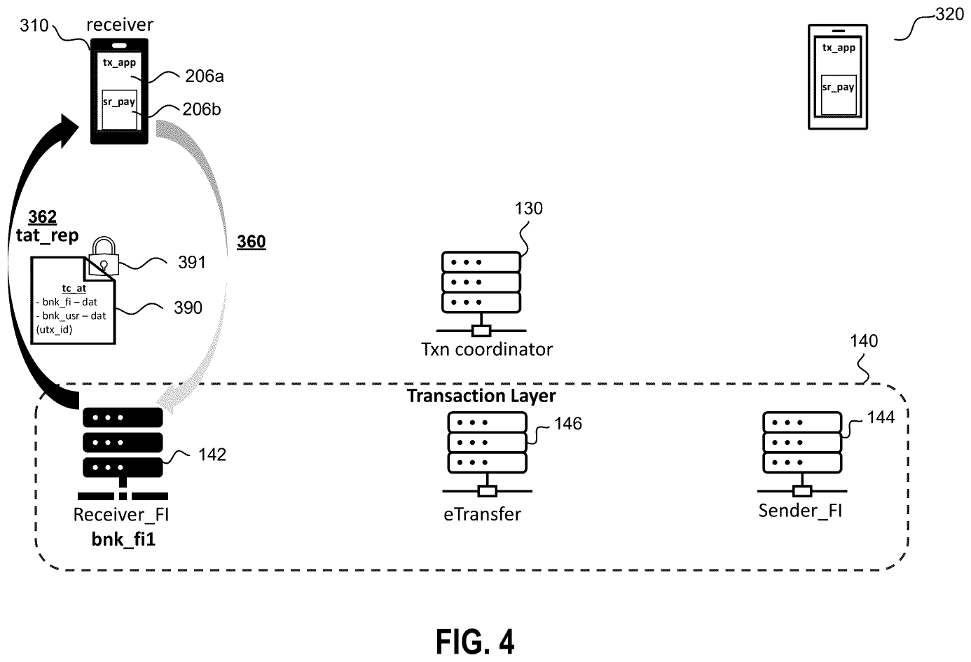

Referring to FIG. 4, the resource system 142 may conduct operations to retrieve a user transaction identifier associated with the bank application user identifier. In some embodiments, the resource system 142 may conduct operations to generate a user transaction identifier and associate the generated user transaction identifier with the bank application user identifier.

In some embodiments, the user transaction identifier may be a universally unique identifier (UUID) associated with the user of the recipient device 310. The UUID may be generated by the resource system 142 for identifying a recipient user and an associated resource account. In contrast to implementations of transaction layer platforms 146 utilizing email addresses or telephone numbers as user identifiers, a user transaction identifier, such as an UUID, may be a persistent identifier that may not be migrated to other resource systems for other usages.

For example, a UUID may be a 128-bit number used to identify data sets within computer systems. An example UUID may be: 123e4567-e89b-12d3-a456-426614174000, in its canonical textual representation, the 16 octets of a UUID are represented as 32 hexadecimal (base-16) digits, displayed in five groups separated by hyphens, in the form 8-4-4-4-12 for a total of 36 characters (32 hexadecimal characters and 4 hyphens).

In some embodiments, the short range transfer system 100 may utilize a modified v4 UUID construct, with a first group of characters modified to represent data about an administrator user of the resource system 570. Other UUID formats, such as v5 UUIDs, may be used.

Table 1 (below) provides an overview of characteristics of UUIDs (example of persistent proximity identifiers), email addresses, and telephone numbers when used as an identifier for resource transfer platforms.

TABLE 1

| | | Phone | | |
|---|---|---|---|---|
| | Email | Number | UUID | Notes |
| Identifier Registrations | Yes | Yes | No | UUIDs are not designed to be migrated |
| are Portable between | | | | between resource systems 570 (e.g., |
| resource systems 570 | | | | banking institutions) |
| Identifier Registrations | Yes | Yes | No | Emails and Phone numbers can be |
| can be moved on | | | | reregistered for Auto Deposit at another |
| demand/without | | | | resource system 570 |
| warning | | | | |
| Owned/Controlled By | Yes | Yes | No | Email Addresses and Phone numbers |
| End User | | | | belong to the client device user, and are not |
| | | | | directly controlled by the resource system |
| | | | | 570 |
| Owned/Controlled By | No | No | Yes | UUID registrations are strictly owned and |
| Issuer | | | | controlled by the registering resource |
| | | | | system 570 |
| Must Be Refreshed | Yes | Yes | No | UUIDs cannot be assigned to another user |
| Periodically with | | | | or migrated to |
| support of End User | | | | |
| Are considered | Yes | Yes | No | Registration UUIDs are not intended to be |
| Personally Identifiable | | | | shared with or by client device users |
| Information | | | | |
| Can be impacted | Yes | Yes | No | UUIDs configured to be managed by the |
| external systems | | | | registering resource system 570 and/or the |
| | | | | resource transfer platform 580 (e.g., |
| | | | | Interac ™ e-transfer platform or other |
| | | | | resource movement networks) |
| Are intended to be | Yes | Yes | No | Emails and Phone Numbers are configured |
| shared by End Users | | | | to be shared because of the utility provided |
| | | | | by the other systems they are used for |
| Registration can be | No | No | Yes | Unlike Email Addresses/Phone Numbers, |
| decoupled from the | | | | where the identifier is the alias to be |
| Identifier | | | | shared, UUIDs can map to temporal |
| | | | | proximity identifiers that can be shared on |
| | | | | other systems, and by other means, |
| | | | | allowing the discovery to happen without |
| | | | | the need to lookup share the actual |
| | | | | identifier. |

In some described embodiments, a user transaction identifier may be a long-lived identifier of a persistent nature. In some other embodiments, the user transaction identifier may be a one-time use identifier or other short-lived identifier.

Referring still to FIG. 4, the resource system 142 may generate a transaction coordinator authentication token 390. In some embodiments, the transaction coordinator authentication token 390 may include a resource system identifier (such as an alpha-numeric sequence identifying a banking organization, such as an issuer number) and the bank application user identifier. For example, the bank application user identifier may include a user transaction identifier (e.g., UUID), a name of the banking application user, or a user identification of the user associated with the resource system 142.

In some embodiments, the transaction coordinator authentication token 390 may include the following data types and be provided based on the following data structure:
“legal_name_initials”: “TS”, “participant_id”: “CA000099”, “uuid”: “e93a473c-cfa5-4354-960a-08fc07d72d70”, “internal_uuid”: “937165c8af2e”, “nickname”: “OtherNickname”, “participant_user_id”: “Second_User@beta.inter.ac”, “created_at”: “2023-10-04T19: 03:21.745Z”, “first_name”: “Toby”, “last_name”: “SecondUser”, “preferences”: { }, “nickname_last_updated”: null, “photo_last_updated”: null, “status”: “active”, “photo_url”:]

In some embodiments, the resource system 142 may sign the generated transaction coordinator authentication token 390 based on a private key 391 of a private key infrastructure (PKI) key pair. In some embodiments, the private key 391 may represent a private key associated with the resource system 142. At operation 362, the resource system 142 transmits the signed transaction coordinator authentication token 390 to the recipient device 310, and the short-range transfer application 206b may include operations for receiving the signed transaction coordinator authentication token 390 for downstream operations.

In the above example, the transaction coordinator authentication token 390 is described as being signed based on a PKI key pair. In the present example, operations for generating the signed transaction coordinator authentication token 390 may be useful for authenticating the resource system 142 (associated with a banking institution) as a known or trusted data source for data values such as the resource system identifier or the bank application user identifier, among other data values, for downstream short-range transfer operations. In some other embodiments, other infrastructure to facilitate secure electronic transfer of data packets may be used.

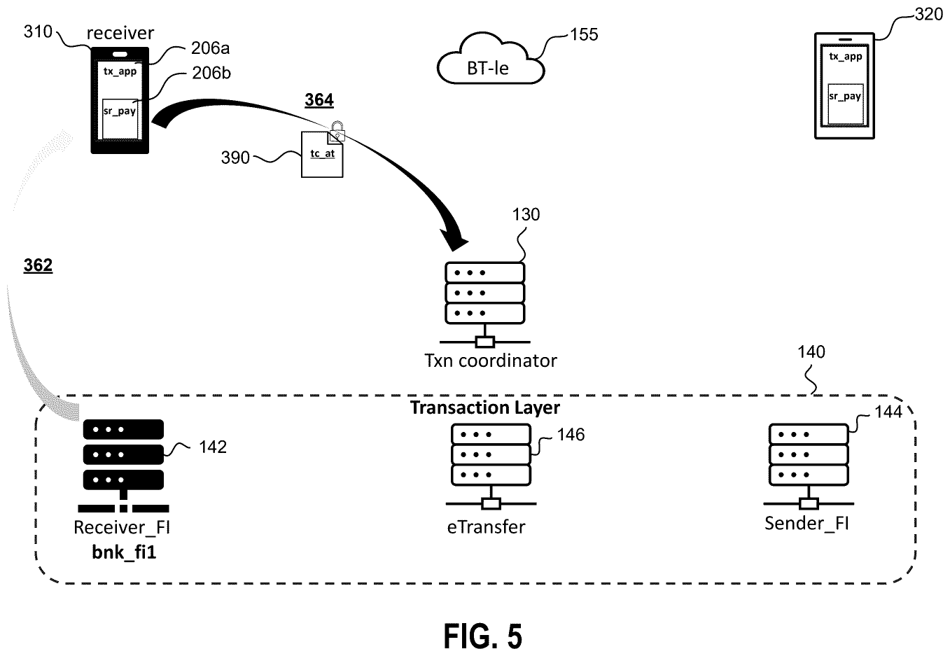

Referring to FIG. 5, at operation 364, the recipient device 310 may transmit the signed transaction coordinator authentication token 390 to the transaction coordinator system 130. In some examples, the transaction coordinator system 130 may be referred to as a short-range transaction coordinator configured for facilitating short-range resource transfers among users of proximally located computing devices.

In some embodiments, the signed transaction coordinator authentication token 390 may be transmitted to the transaction coordinator system 130, and in some other embodiments, the signed transaction coordinator authentication token 390 may be transmitted by calling an authentication endpoint.

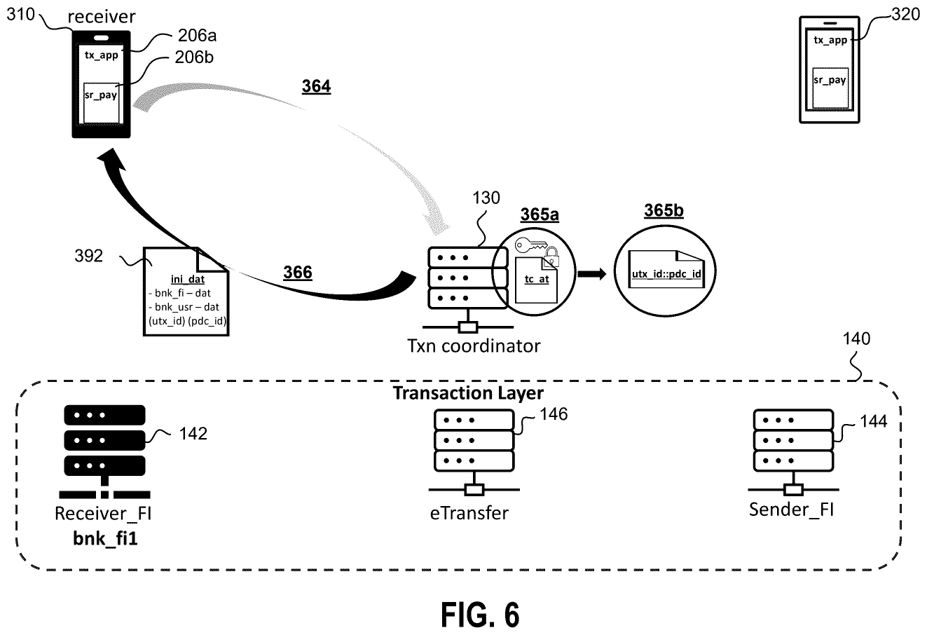

Referring to FIG. 6, the transaction coordinator system 130 may conduct operations to receive the signed transaction coordinator authentication token 390. The transaction coordinator system 130, at operation 365a, may obtain a public key of a PKI key pair associated with the resource system 142 and may conduct operations for decrypting or otherwise accessing the data structure of the signed transaction coordinator authentication token 390 and validating the data values therein.

At operation 365b, the transaction coordinator system 130 may determine whether the user transaction identifier may already be associated with a proxy user discovery identifier (such as a UUID).

In a scenario where the user transaction identifier may not be associated with a proxy user discovery identifier, the transaction coordinator system 130 may generate a proxy user discovery identifier based on a seed value determined via a pseudo-random set of operations or functions and may associate the generated proxy user discovery identifier with the user transaction identifier. In some embodiments, the proxy user discover identifier may be session specific or ephemeral in nature.

In some scenarios, the proxy user discovery identifier may be generated and used on a session-by-session basis or may be valid on a time-limited basis. The proxy user discovery identifier may not be persistently associated with a given computing device or user to reduce or thwart effects of unscrupulous attempts at proximity user discovery identifier harvesting practices. For example, because proximity user discovery identifiers may be limited in time or limited by time-limited nature of active sessions, an unscrupulous user device conducting operations to conduct data harvesting processes (e.g., detecting proxy user discovery identifiers of proximally located computing devices for unscrupulous purposes) for downstream operations of spoofing or mimicking other devices based on proximity user discovery identifiers may be unsuccessful, as proximity user discovery identifiers may be time-limited in nature.

In the scenario where the user transaction identifier may already be associated with a proxy user discovery identifier and where the identified proxy user discovery identifier continues to be validly associated with the user transaction identifier, the transaction coordinator system 130 may generate an initialization data set 392.

At operation 366, the transaction coordinator system 130 generates an initialization data set 392 and transmits the initialization data set to the short-range transfer application 206b at the recipient device 310.

In some embodiments, the initialization data set 392 may include a combination of data values for promulgating short-range resource transfer operations of embodiments of the present disclosure. For example, the initialization data set 392 may include: identifying information associated with the resource system 142 (e.g., an alpha-numeric sequence identifying a banking institution, such as an issuer number), or identifying information associated with the user of the transaction application 206a. For example, the banking application user may associate a user transaction identifier (e.g., UUID), a name of the user, a user identifier of the user at the resource system 142, or a proxy user discovery identifier with a user.

In some embodiments, initialization data set 392 may include the following data types and be provided based on the following data structure:
“legal_name_initials”: “FU”, “participant_id”: “CA000099”, “uuid”: “e93a473c-cfa5-4354-960a-08fc07d72d90”, “internal_uuid”: “0d8c731b24a5”, “nickname”: null, “participant_user_id”: “4USER@beta.inter.ac”, “created_at”: “2023-10-04T19: 54:54.367Z”, “first_name”: “FOUR”, “last_name”: “USER”, “preferences”: { }, “nickname_last_updated”: null, “photo_last_updated”: null, “status”: “pending”]

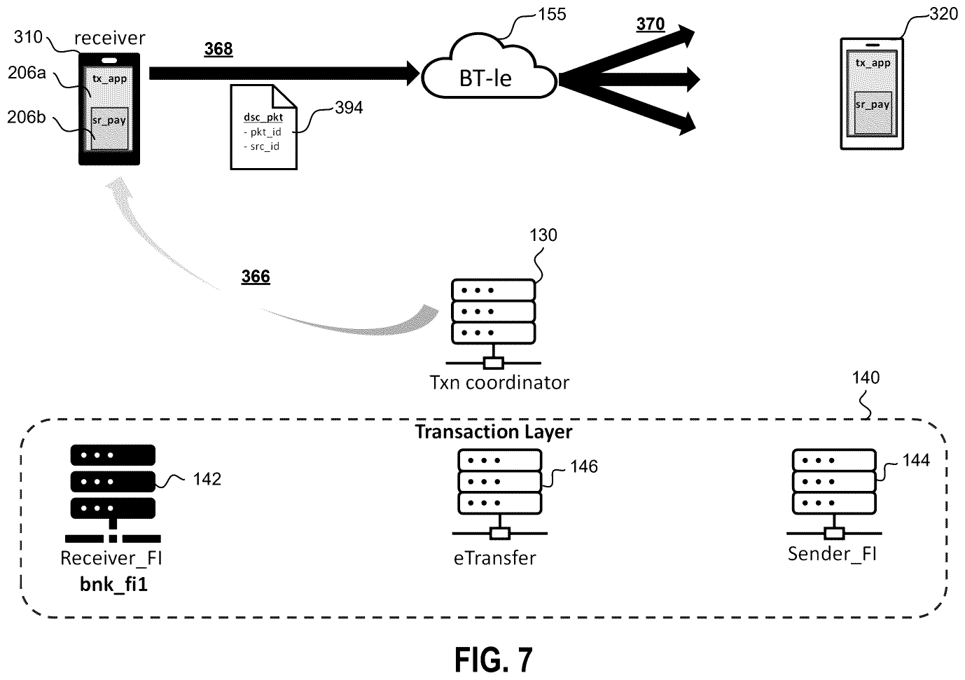

Referring to FIG. 7, the recipient device 310 may include operations to the initialization data set 392 (FIG. 6). At operation 368, the short-range transfer application 206b may include instructions that when executed conduct operations to generate a transaction discovery packet 394.

In some embodiments, the transaction discovery packet 394 may include a type identifier for indicating that the transaction discovery packet 394 may be a data set associated with a short-range resource transfer operation. The type identifier may be a data value or flag to indicate that the transaction discovery packet 394 is configured to initiate a proposed short-range transaction.

The transaction discovery packet 394 may further include an instance or source identifier value for identifying a source of the transaction discovery packet 394. In some embodiments, the instance or source identifier may be a proxy user discovery identifier generated at a prior operation of the transaction coordinator system 130.

In scenarios where the computing device is operating as an initiating transfer device for requesting receipt of particular resources, the transaction discovery packet 394 may include data fields storing data values for operations for allowing computing devices to be discoverable by other similarly initialized and configured computing devices.

At operation 370, the recipient device 310 may conduct operations to broadcast the transaction discovery packet 394 via the short-range network 155. In some embodiments, the short-range network 155 may be a Bluetooth™ low energy communication network or a near-field communication network. The transaction discovery packet 394 may be periodically broadcast for allowing the recipient device 310 to be discoverable by another similarly initialized and configured computing device. In some embodiments, the similarly initialized and configured computing device may be one or more sender devices 320.

In embodiments where the short-range network 155 may be a Bluetooth™ low energy network, the transaction discovery packet 394 may be generated and transmitted as a Bluetooth™ broadcast discovery frame.

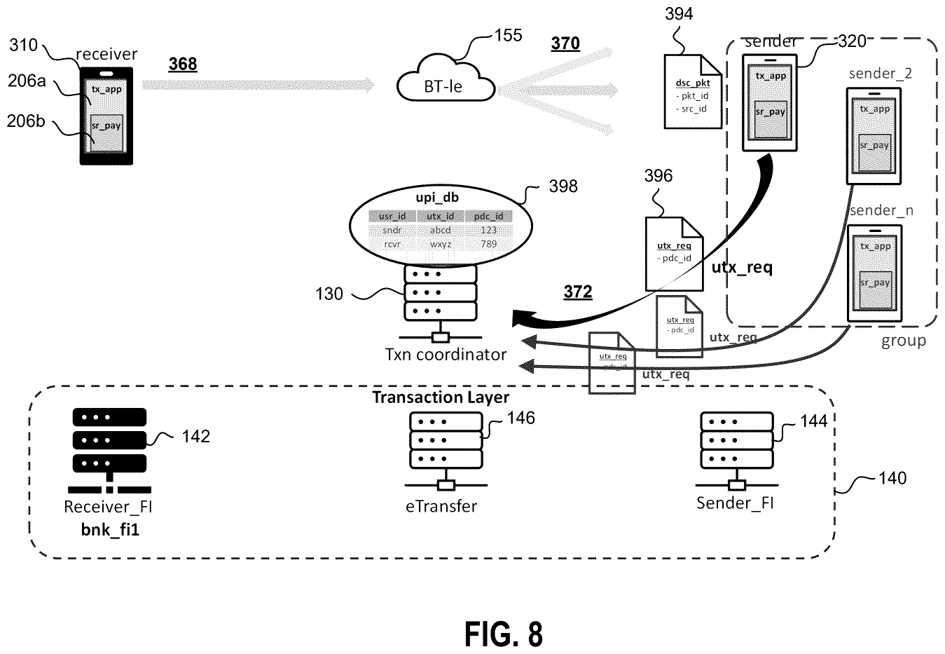

Referring to FIG. 8, one or more sender devices 320 may be within physical proximity to the recipient device 310 and the one or more sender devices 320 may, via the short-range network 155, detect or receive the transaction discovery packet 394 broadcasted by the recipient device 310.

The respective one or more sender devices 320 may have already conducted operations for initialization associated with short-range resource transfer operations. The one or more sender devices 320 may be configured to detect the transaction discovery packet 394 broadcasted by the recipient device 310.

The sender device 320 may conduct operations to determine based on the type identifier data field that the transaction discovery packet 394 is for initiating a short-range resource transfer operation. The sender device 320 may additionally conduct operations for parsing the transaction discovery packet 394 for identifying a source identifier, such as the proxy user discovery identifier associated with a user of the recipient device 310.

The short range-transfer application 206b may include instructions that, when executed by a processor, generate a user transaction identifier request 396. The user transaction identifier request 396 may be configured for retrieving or determining a user transaction identifier (such as a UUID) that is associated with the identified proxy user discovery identifier.

At operation 372, the respective sender devices 320 may transmit respective user transaction identifier requests 396 to the transaction coordinator system 130 for querying or determining a user transaction identifier that is associated with the identified proxy user discovery identifier.

In scenarios where two or more recipient devices 310 may have broadcast transaction discovery packets 394 via the short-range network 155, the respective sender devices 320 may transmit subsequent or additional user transaction identifier requests 396 to the transaction coordinator system 130 for querying or determining a user transaction identifier associated with respective identified proxy user discovery identifiers.

The transaction coordinator system 130 may conduct operations to receive the one or more user transaction identifier requests 396. The transaction coordinator system 130 may query an identifier database 398 for correlating respective proxy user discovery identifiers with user transaction identifiers (such as UUIDs). For example, the transaction coordinator system 130 may conduct data structure look-ups from the identifier database 398 to associate user transaction identifiers with the received proxy user discovery identifiers. As described in examples herein, the user transaction identifiers may be persistent identifiers associated with a user and/or a user asset account at a particular banking institution.

As described, the proxy user discovery identifiers may be recognized for a limited duration of time, or on a session-by-session basis, to reduce or thwart undesired proxy user discovery identifier harvesting practices that may be used for unscrupulous downstream operations to mimic or spoof transaction discovery packets for promulgating unauthorized resource transfers to unscrupulous users of recipient devices.

In some embodiments, the transaction coordinator system 130 may conduct operations for determining whether one or more computing devices may be submitting a large quantity of user transaction identifier requests 396 per unit time beyond a threshold value. In such scenarios where the transaction coordinator system 130 determines that a given computing device may be submitting a large quantity of user transaction identifier requests 396 over time beyond a threshold value, the transaction coordinator system 130 may infer that the identified computing device may be unscrupulously harvesting proximity identifier data for a potentially malicious or unintended purpose. Accordingly, the transaction coordinator system 130 may conduct operations to throttle or temporally halt operations for identifying user transaction identifiers associated with proxy user discovery identifiers received with the user transaction identifier requests 396. In some embodiments, the transaction coordinator system 130 may conduct operations to generate an alert for transmitting to a system operating a fraud detection application. In some embodiments, the fraud detection application may be provided at a recipient banking institution system 142 or a sender banking institution system 144. Such generated alerts may be configured to notify fraud detection users of potential unscrupulous operations associated with the short-range transfer system 100.

In some embodiments, operations to determine whether the given device may be submitting a large quantity of user transaction identifier requests 396 to the transaction coordinator system 130 over time beyond a threshold rate may be conducted at the sender devices 320. When conducted at the respective sender devices 320, the short-range transfer application 206b may include operations to throttle or temporally halt operations for identifying user transaction identifiers (such as UUIDs) associated with proxy user discovery identifiers received with the user transaction identifier requests 396.

In an example, the recipient device 310 and the two or more sender devices 320 may be associated with users of a group dining at a restaurant. A user associated with the recipient device 310 may have paid the full meal cost, and the users associated with the respective sender devices 320 may wish to reimburse the user of the recipient device 310 for a portion of the full meal cost. The proposed quantity of resource transfer from users of the sender devices 320 may be equally the same or may be different.

In scenarios where the recipient device 310 operates as an initiating transfer device, the recipient device 310 may conduct operations to request receipt of resources from the two or more sender devices 320. The recipient device 310 may broadcast, via the short-range network 155, one or more transaction discovery packets 394, and sender devices 320 physically proximal may detect the one or more transaction discovery packets 394. The transaction discovery packets 394 may include data values representing the request of a quantity of resources from one or more sender devices 320 within physical proximity of the recipient device 310.

In the present example, upon detecting at least one transaction discovery packets 394, the one or more sender devices 320 may conduct operations to generate respective user transaction identifier requests 396 in accordance with example operations with reference to FIG. 8. For example, the sender device 320 may generate and transmit a user transaction identifier request 396 to the transaction coordinator system 130 for querying or determining a user transaction identifier (UUID) based on an proxy user discovery identifier from the prior detected transaction discovery packets 394.

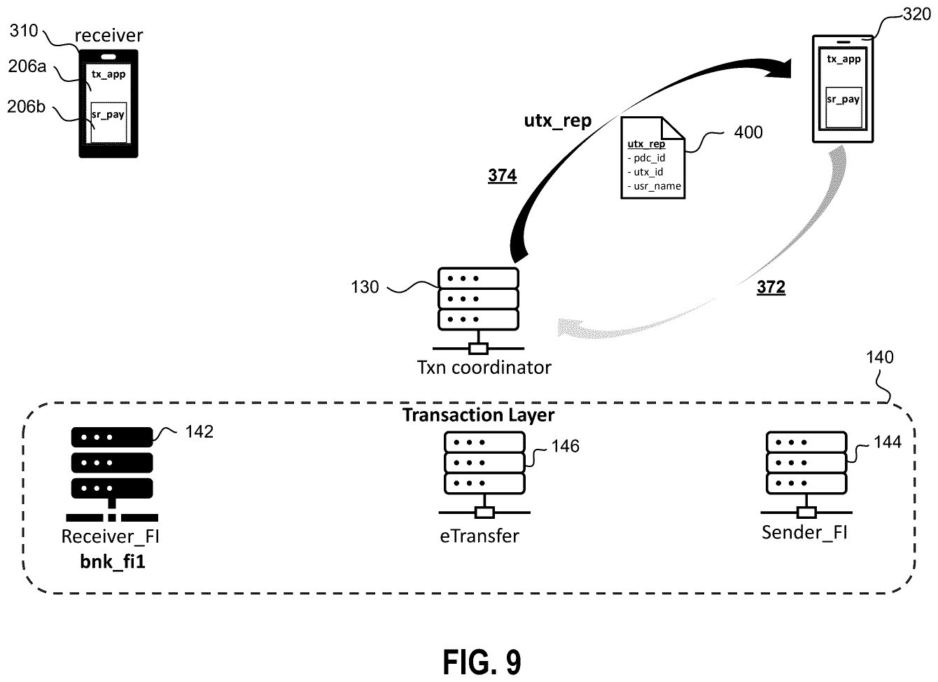

Referring to FIG. 9, in response to receiving the user transaction identifier request 396, the transaction coordinator system 130 at operation 374 may conduct operations for generating a user transaction reply 400. In some embodiments, the user transaction reply 400 may include: (i) the proxy user discovery identifier and the associated user transaction identifier; and (ii) an alias identifier such as a user name for downstream display at the computing device. The alias identifier may be a user nickname for a user of the recipient device 310 or a representative photo for the user.

In scenarios where the transaction coordinator system 130 receives multiple user transaction identifier requests 396 associated with detected transaction discovery packets 394, the transaction coordinator system 130 may conduct look-up queries from the identifier database 398 in response to the respective user transaction identifier requests 396, and subsequently generating a user transaction reply 400 message for the respective user transaction identifier requests 396.

In some embodiments, to supplement look-up queries for generating user transaction reply 400 messages, the transaction coordinator system 130 may determine associated identification sharing permission assignments. For example, the recipient device 310 may generate the transaction discovery packet 394 to indicate the quantity of alias identifier data that may be included with the user transaction reply 400 messages for downstream short-range resource transfer operations. For example, optional alias identifier data associated with a user of the recipient device 310 may include representative photos, nicknames/pseudonyms, organization name data, among other example alias data.

In some embodiments, the user transaction reply 400 message may include the proxy user discovery identifier and associated user transaction identifier (such as a UUID), and a data value indicating that the proxy user discovery identifier is associated with a user that has previously undertaken authentication operation at the transaction coordinator system 130. In some embodiments, the user transaction reply 400 message may be in an encrypted form, and that the data values therein are not as plain text values.

In scenarios where electronic transactions or asset transfers may be effected or completed based on electronic data messages exchanged among computing devices and systems, it may be desirable to provide operations to substantiate that data messages or data packets originate from a recognized source device, are un-altered during transmission, or are otherwise accurate. Accordingly, embodiments described in the present disclosure include features to establish trust features as between devices or systems of the short-range transfer system 100 (FIG. 1), such as to verify data packet origin, verify that data packets have not been altered, or verify that data packets are accurate for effecting downstream electronic transaction operations.

For example, referring again to FIG. 1, some embodiments described herein include methods of generating or transmitting data messages or packets as exchanged between the recipient banking institution system 142 and the transaction coordinator system 130 for establishing trust features.

In some embodiments, generating or transmitting data messages or packets as exchanged between the sender banking institution system 144 and the transaction coordinator system 130 may be for establishing trust features.

Further, in some embodiments described herein, generating or transmitting data messages or packets exchanged between the respective recipient device 110 or the sender device 120 and the transaction coordinator system 130 may be for establishing trust features.

Accordingly, embodiments of such data packet messaging features may substantiate a level of trust as between devices and systems of the short-range transfer system 100 for facilitating transient-type transactions.

Embodiments described with reference to FIGS. 3 to 9 include operations for initialization and/or discovery of computing devices 200 for short-range electronic transfer operations. One-off transactions, such as cash-type transactions, may be useful at retail marketplaces or in other scenarios where users may not contemplate a future transaction interaction whilst interacting within close physical proximity of one another.

To conduct such types of one-off electronic transactions whilst reducing the quantity of personally identifiable information or persistent data to be shared among the users of computing devices, embodiments of the transaction coordinator system 130 may conduct operations to generate proxy user discovery identifiers and associate the proxy user discovery identifiers with a user transaction identifier, such as a UUID.

As described herein, user transaction identifiers may be associated with a user account for a particular banking institution and may not be altered or utilized for other purposes. Further and in contrast, a proxy user discovery identifier (associated with a user transaction identifier) may be generated and associated to a user transaction identifier on a discovery session-by-session or time-limited basis. That is, embodiments of proxy user discovery identifiers may be ephemeral in nature. Upon expiry of the session or limited time duration, and the transaction coordinator system 130 may thwart generation of user transaction reply messages 400 based on expired proxy user discovery identifiers.

As will be described, the transaction coordinator system 130 may generate user transaction reply messages 400 as a precursor step to enable a computing device 200 to generate transactions for asset transfers to other computing devices. Because proxy user discovery identifiers may be discovery session or time-limited in nature, upon the passage of a time duration, computing devices 200 may not generate transactions to other computing devices based upon a prior-expired proxy user discovery identifier.

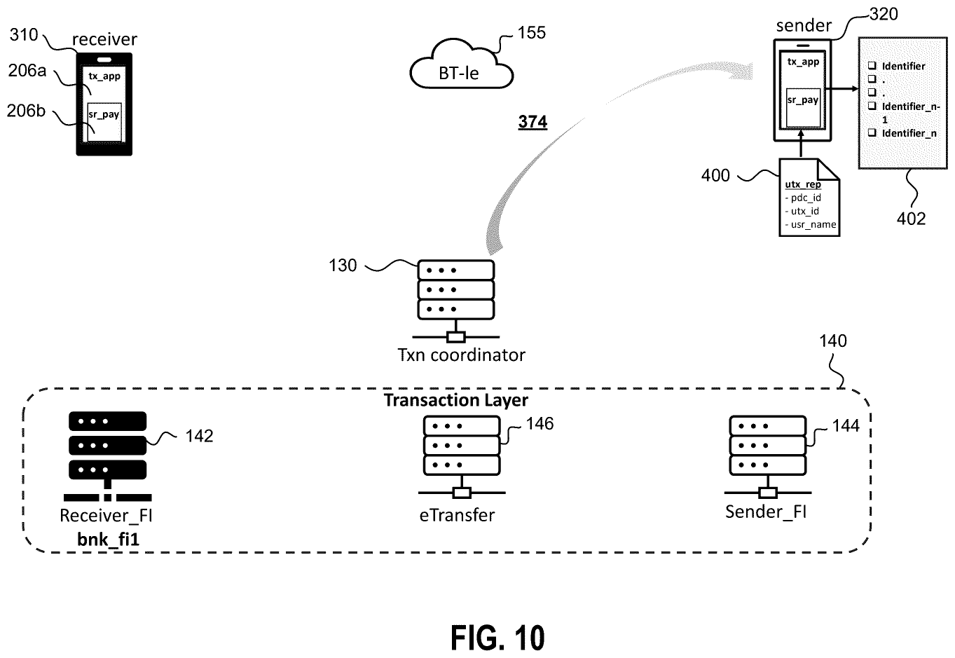

Reference is made to FIGS. 10 to 14, which illustrate a method of short-range electronic transactions among discovered computing devices physically proximal other computing devices, in accordance with embodiments of the present disclosure.

As described with reference to FIG. 9, at operation 374, the transaction coordinator system 130 may generate a user transaction reply 400 including a user transaction identifier (such as a UUID) associated with the prior-detected proxy user discovery identifier. The prior-detected proxy user discovery identifier may have been broadcast in a transaction discovery packet 394 via the short-range network 155, and the prior-detected proxy user discovery identifier may be associated with a user account/user of the recipient device 310. The transaction coordinator system 130 may transmit the user transaction reply 400 to the sender device 320.

In scenarios where the prior-detected proxy user discovery identifier may have expired due to an expired discovery session among computing devices, or may have expired based on a passage of a limited time duration, the transaction coordinator system 130 may not generate a suitable user transaction rely 400 having (i) the user transaction identifier associated with an unexpired proxy user discovery identifier; and (ii) an alias identifier such that the sender device 320 may generate transaction data sets for an asset transfer.

In scenarios where the prior-detected proxy user discovery identifier continues to be current within a discovery session or a time duration, the sender device 320 may determine an alias identifier and a user transaction identifier associated with the prior-detected proxy user discovery identifier based on the user transaction reply 400.

Further, the sender device 320 may generate a user interface 402 for initiating a proposed short-range transfer. The proposed short-range transfer may include a transfer of assets to a user account of the recipient device 310. The user interface 402 may include a listing of one or more alias identifiers for generating a proposed short-range transfer.

In some embodiments, the alias identifier may be a nickname, pseudonym, or representative photo associated with a user of the recipient device, and may be enumerated based on the received user transaction reply 400. In scenarios where the sender device 320 may have detected two or more transaction discovery packets 394, the generated user interface 402 may include a listing of alias identifiers respectively corresponding to a detected transaction discovery packet 394. The sender device 320 may generate the user interface 402 to include two or more alias identifiers representing multiple potential recipient devices within a near proximal range of the sender device.

In some embodiments, the alias identifier may include a nickname, pseudonym, or representative photo, among other example alias identifiers, displayed at the sender device 320. As the proposed short-range transfer is as between computing devices within a proximal geographical location of one another, being able to verify in substantially real time information from the alias identifier with a user of the recipient device 310 may provide users with an additional level of validation that the proposed short-range transfer may be for the intended user of the recipient device.

For example, in scenarios where the alias identifier includes a representative photo, the user of the sender device 320 may conduct a visual validation that the representative photo represents a likeness of the user of the recipient device 310. In another example, where the alias identifier includes a nickname or pseudonym, the user of the sender device 320 may verbally validate with the user of the recipient device 310 that the alias identifier corresponds to the user of the recipient device 310.

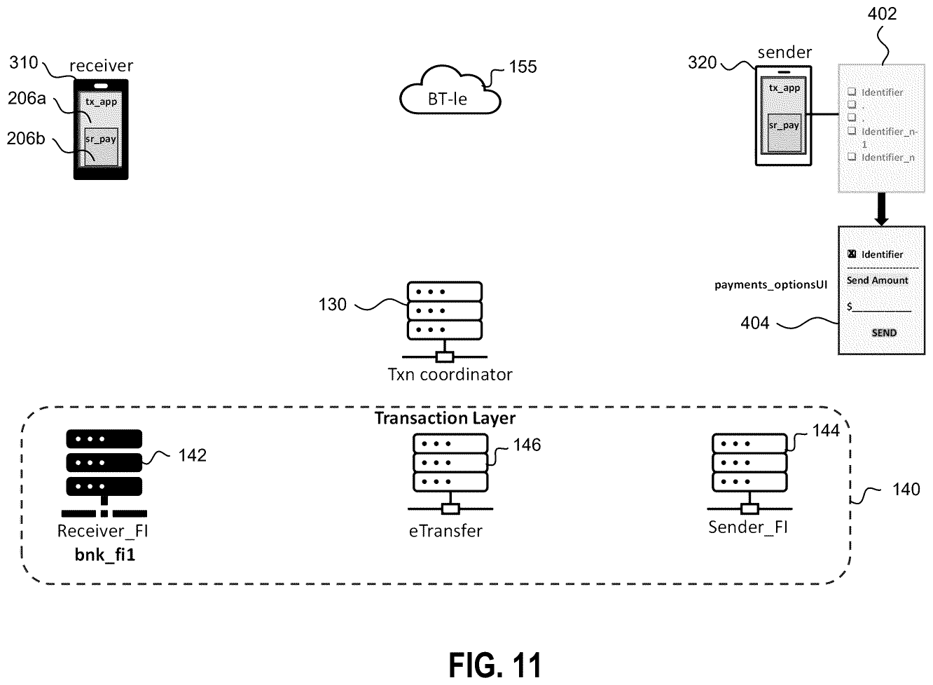

Upon receiving user input for selecting at least one alias identifier for initiating a proposed short-range transfer, the sender device 320 may generate further user interfaces for receiving user input for constructing a short-transfer transaction data set. Referring to FIG. 11, the sender device 320 may generate a payment options interface 404 for retrieving payment transfer details.

For example, the payment operations interface 404 may include user interface elements for obtaining a quantity of assets or money intended to be transferred to the user of the recipient device 310, or may include user interface elements for obtaining indication of the source bank account at the sender banking institution 144 from which money is to be debited for the short-range transfer.

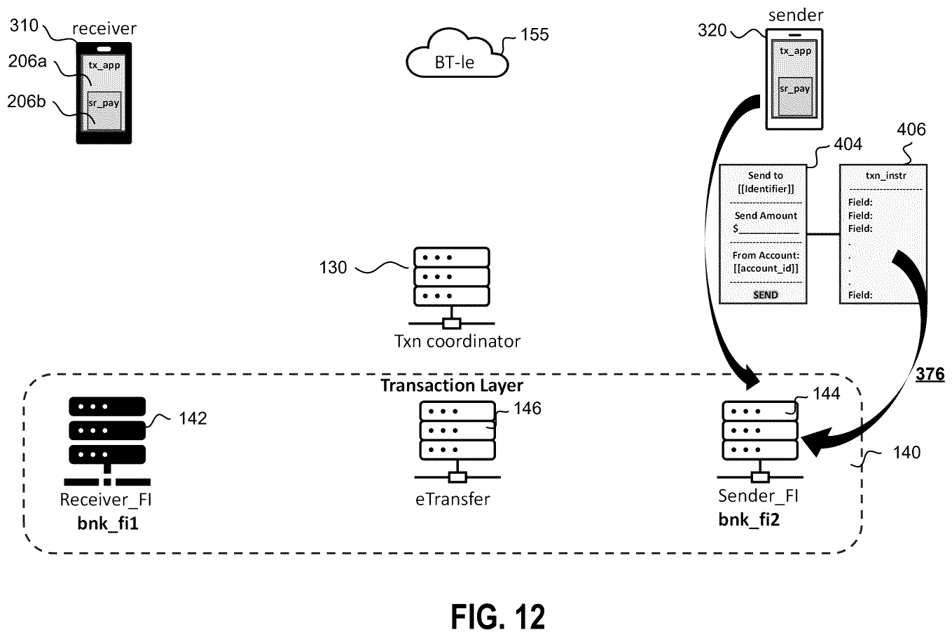

Referring to FIG. 12, the sender device 320 may generate the short-transfer transaction data set 406 for initiating the short-range transfer. The short-range transaction data set 406 may include data values necessary for effecting the transaction by the transaction layer platform 146 for transferring assets from an account at the sender banking institution system 144 to the recipient banking institution system 142.

In an example of the transaction layer platform 146 being the Interac™ e-Transfer platform, the short-range transaction data set 406 may include: an indicator of the selected account (e.g., recipient account at the recipient banking institution 142), a user transaction identifier (e.g., UUID) of the user of the recipient device 310, a quantity of assets for transferring to the user of the recipient device 310, among other data values for carrying out the short-range transaction.

In some embodiments, the short-range transaction data set 406 may be generated based on a JSON payload data structure or array.

In some embodiments, the sender device 320 may generate a user interface 404 for summarizing data values associated with the short-range transaction data set 406 and receive user input for confirming the data values associated with the short-range transaction data set 406.

At operation 376, the sender device 320 may transmit the short-range transaction data set 406 to the sender banking institution system 144 for initiating the short-range transfer at the transaction layer 140.

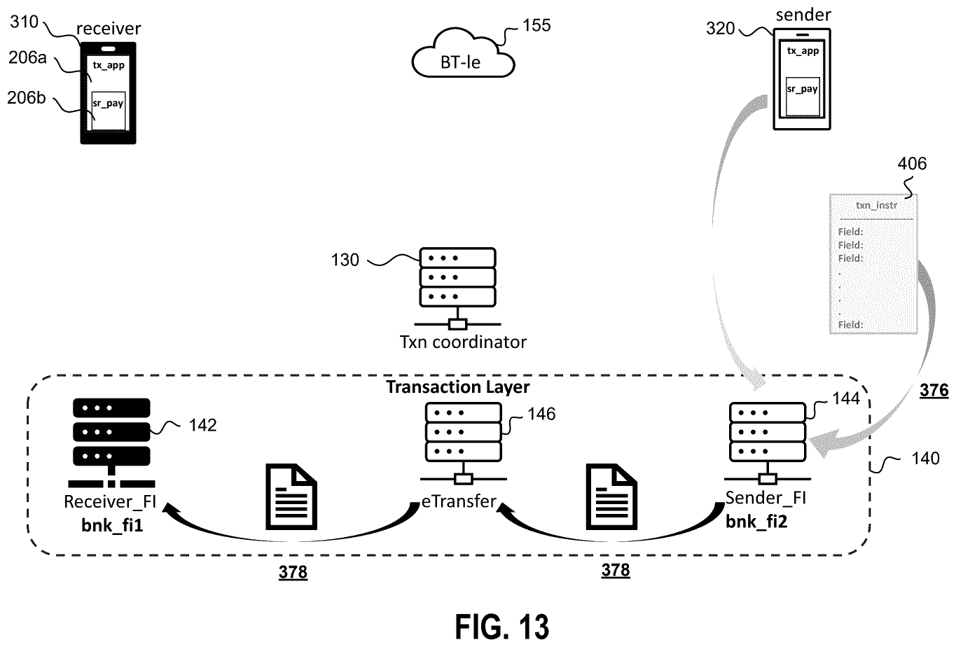

Referring to FIG. 13, at operation 378 the transaction layer platform 146 may conduct operations for liaising and coordinating the asset transfer defined based on data fields of the short-range transaction data set 406. The Interac™ e-Transfer platform is illustrated as an example; however, other transaction layer platforms for facilitating asset transfers may be used, such as real-time rail platforms or other monetary or resource exchange network platforms.

Accordingly, embodiments of the short-range transfer system 100 may be agnostic to the underlying implementation details of the transaction layer 140, so long as features of the signed transaction coordinator authentication token 390 and the short-range transaction data set 406 are generated based on the necessary data values to initiate asset or monetary transfers at the transaction layer 140.

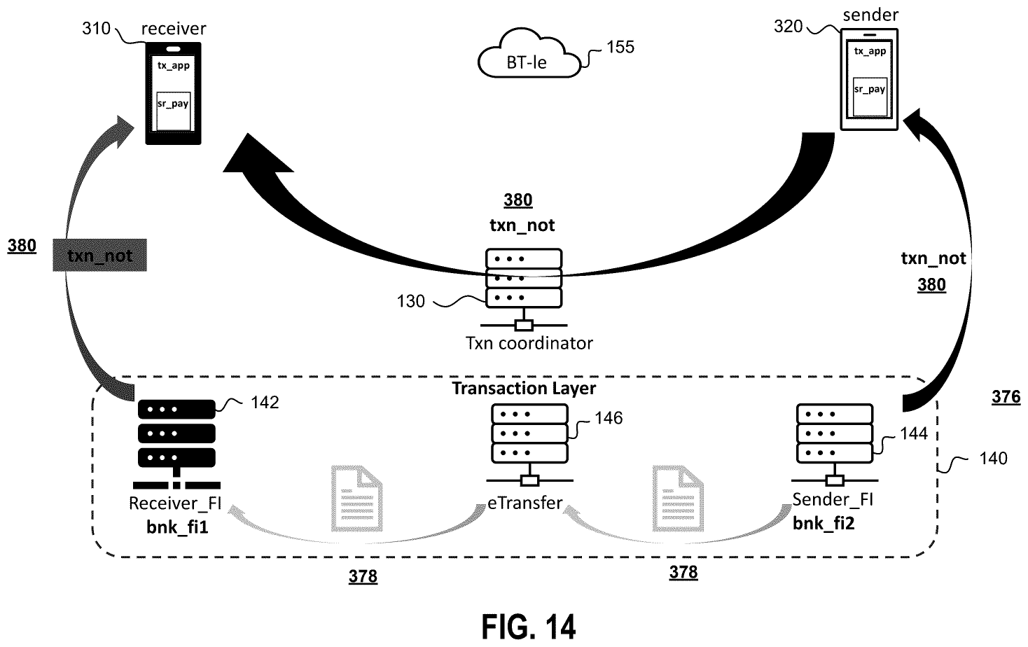

Referring to FIG. 14, upon devices of the transaction layer 140 completing the asset or monetary transfer from the sender banking institution 144 to the recipient banking institution 142, the recipient device 310 and the sender device 320 may receive a transaction notification confirmation 380 that the short-range transfer was completed. In some embodiments, the transaction notification confirmation 380 may be generated as an in-application notification message of the short-range transfer application 206b or as an alpha-numeric message notification based on electronic mail, short message service message, or other notification message channel.

FIGS. 10 to 14 illustrate a sequence of operations of a short-range electronic transactions where the computing device 200 may be a sender device 320 operating as an initiating transfer device for requesting sending of assets to at least one other computing device (e.g., recipient device 310).

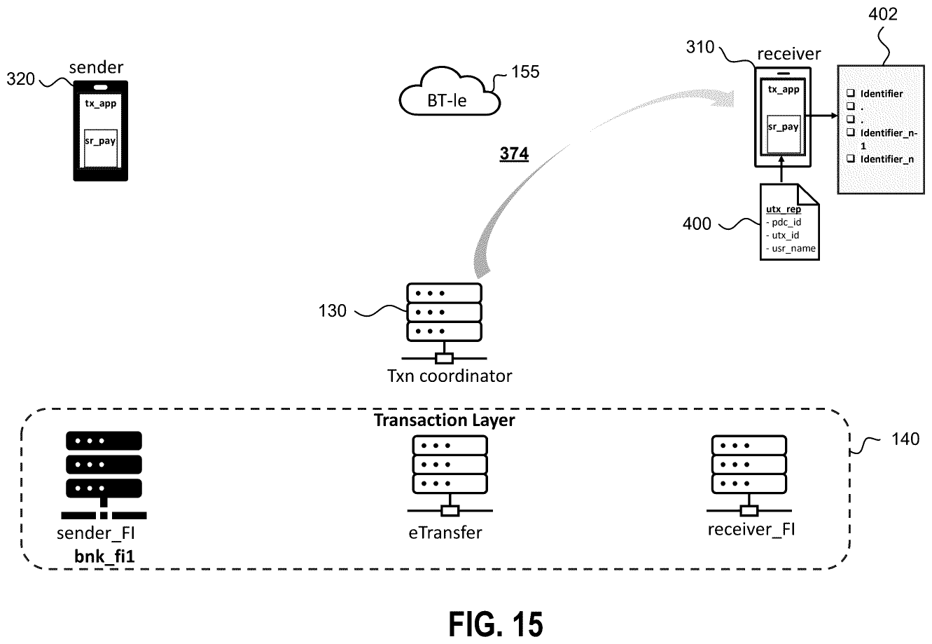

In some scenarios, the computing device 200 may be a recipient device 310 operating as an initiating transfer device for requesting receipt of assets from at least one other computing device (e.g., sending device 320). To illustrate, FIGS. 15 to 17 illustrate a sequence of operations of a short-range electronic transactions where the recipient device 310 operates as the initiating transfer device.

In FIG. 15, the recipient device 310 and the sender device 320 may be in close physical proximity of one another. The recipient device 310 may have conducted prior operations, via the short-range network 155, to detect or receive a transaction discovery packet 394 broadcasted by the sender device 320. Operations of the recipient device 310 to detect or receive the transaction discovery packet 394 may be similar to those operations described with reference to FIG. 8 for detecting the transaction discovery packet 394.

Further, the recipient device 310 may have conducted prior operations to transmit a user transaction identifier request 396 to the transaction coordinator system 130 for determining a user transaction identifier associated with an identified proxy user discovery identifier of the transaction discovery packet 394.

Similar to operations described with reference to FIG. 9, operation 374 may include operations for generating a user transaction reply 400 and transmitting the user transaction reply to the recipient device 310. The user transaction reply 400 may include: (i) the proxy user discovery identifier and the associated user transaction identifier for the sender device 310; and (2) an alias identifier representing the sender device 310.

It may be appreciated that such discovery-related operations may be conducted such that session-limited or time-limited proxy user discovery identifiers may be associated with user transaction identifiers (e.g., UUIDs, etc.) and subsequently used for generating user transaction reply 400 message to initiate short-range transfers.

Referring still to FIG. 15, the recipient device 310 may generate the user interface 402 including a listing of one or more alias identifiers respectively corresponding to a detected transaction discovery packet 394. The user interface 402 may include the alias identifiers representing potential sender devices 320 within a near proximal range of the recipient device 310.

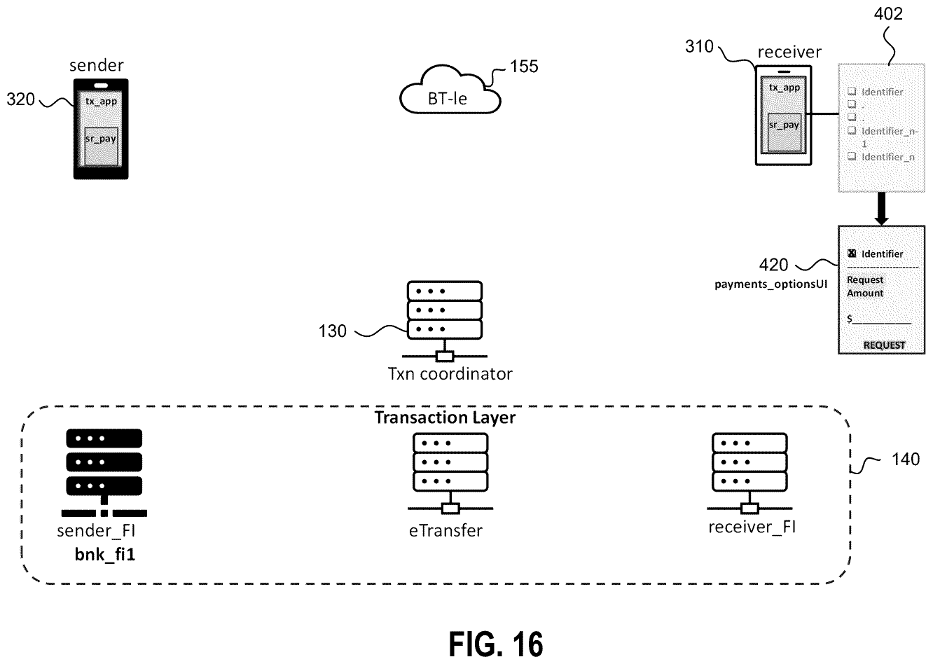

Referring to FIG. 16, the recipient device 310 may generate a payment request interface 420 for retrieving desired payment request details from the user of the recipient device 310. For example, the payment request interface 420 may include user interface elements for obtaining a quantity of assets or money being requested from the user of the sender device 320, or may include user interface elements for obtaining an indication of the recipient bank account at the recipient banking institution towards which money is to be deposited from the short-range transfer.

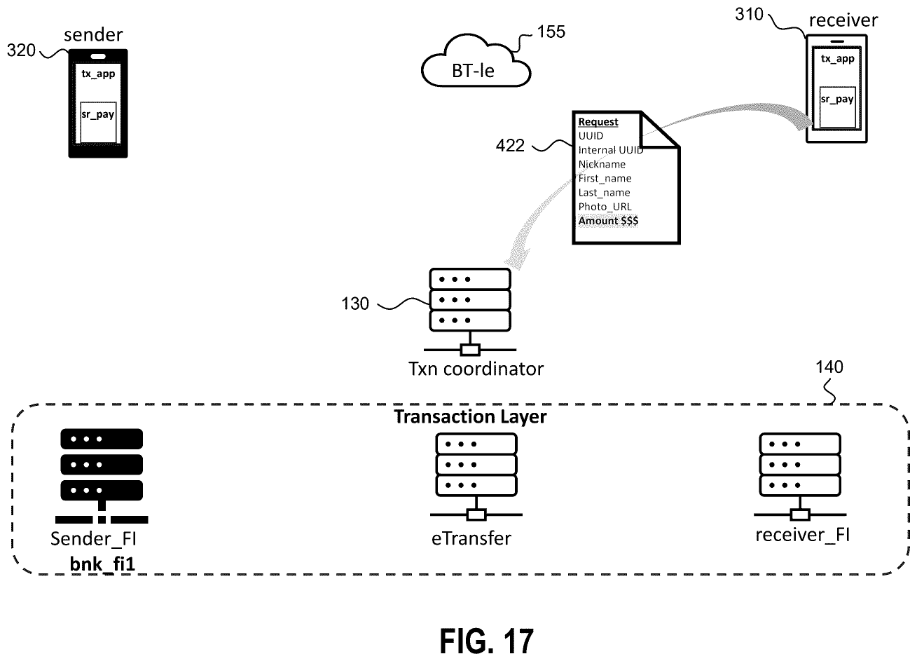

Referring to FIG. 17, the recipient device 310 generates a short-range transfer request 422 and transmit the short-range transfer request to the transaction coordinator system 130 for initiating the short-range transfer request.

In some embodiments, the short-range transfer request 422 may include one or more of the user transaction identifier associated with the prior-identified proxy user discovery identifier, alias identifiers (such as a nickname), other name identifiers of the users, a representative photo of a user of the recipient device 310, and a quantity of assets or money being requested by the recipient user 310. Accordingly, the short-range transfer request 422 may be an instruction data set including pertinent data values from the short-range broadcast/discovery operations described herein for liaising and initiating asset transfers based on existing devices of the transaction layer 140.

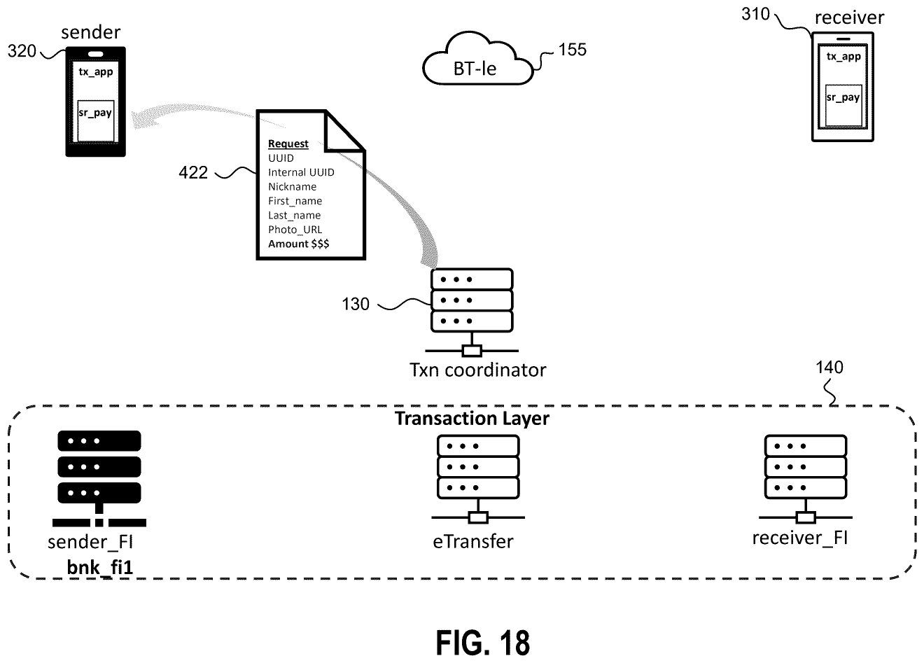

Upon the recipient device 310 initiating the transfer of assets, FIGS. 18 to 21 illustrate a sequence of operations of a short-range electronic transaction where the sender device 320 conducts operations based on a short-range transfer request 422.

Referring to FIG. 18, the sender device 320 may receive the short-range transfer request 422. The sender device 320 may conduct operations of similar to that of an initiating transfer device based on the data values defined based on the short-range transfer request.

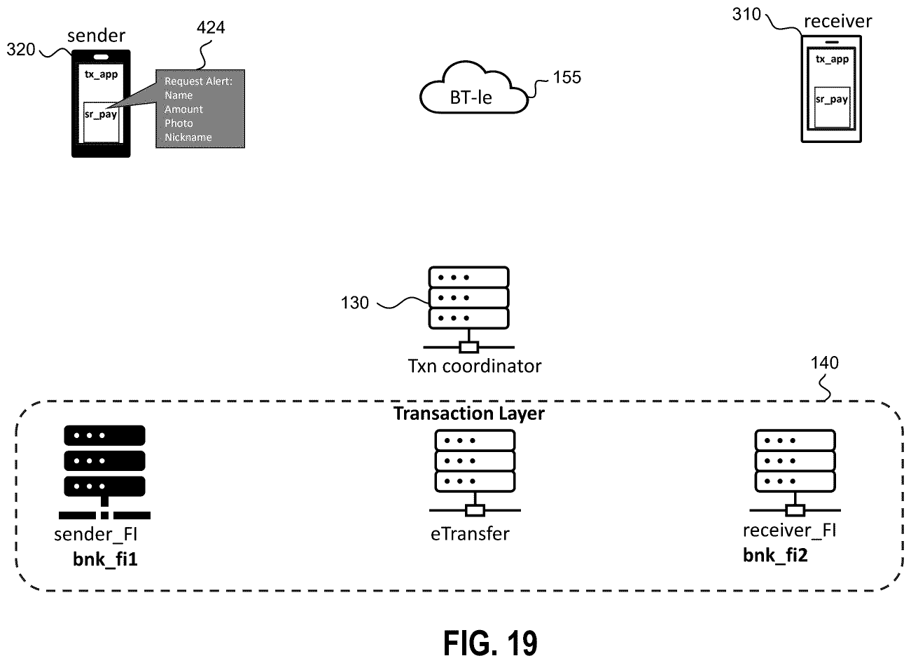

Referring to FIG. 19, the sender device 320 may generate a user interface 424 for displaying details of an asset request. The user interface 424 may include data values associated with alias identifier details, such as a name, asset quantity requested, representative photo, or nickname based on the short-range transfer request 422.

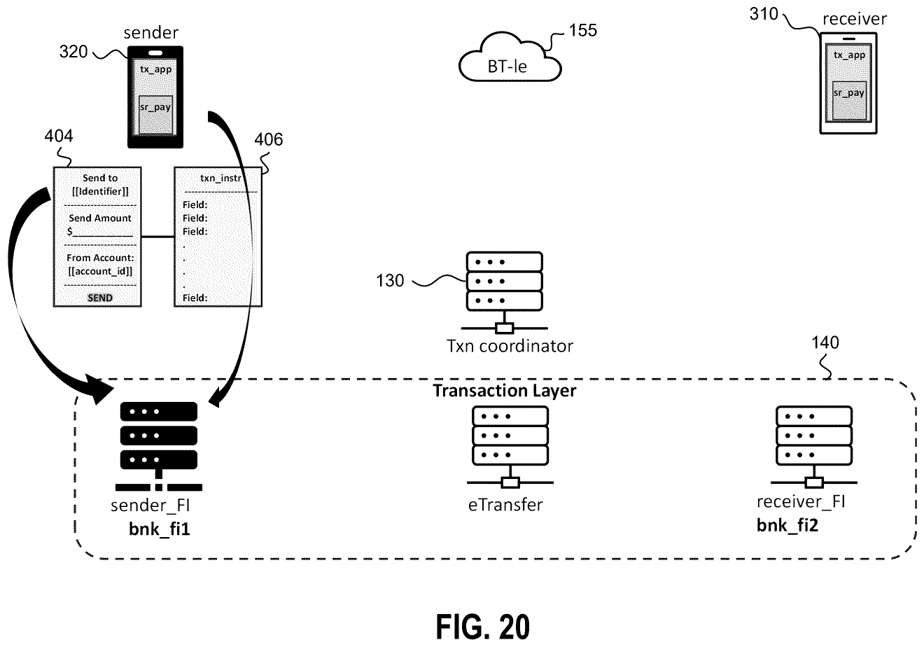

Referring to FIG. 20, the sender device 320 may generate a payment options interface 404 for retrieving payment transfer details. The payment options interface 404 may be similar to the interface described with reference to FIG. 12. The sender device 320 may generate the short-range transaction data set 406 similar to that described with reference to FIG. 12 for initiating the short-range transaction. The short-range transaction data set 406 may include data values necessary for effecting the transaction by devices of the transaction layer 140 for transferring assets from an account of the sender banking institution system to the recipient banking institution system.

It may be appreciated that operations described with reference to FIGS. 15 to 17 are associated with a method for the recipient device 310 to be operating as an initiating transfer device for requesting asset transfer from the sender device 320. Upon the short-range transfer request 422 being generated based on prior broadcast and discovery operations, the sender device 320 may conduct operations as an initiating transfer device for requesting sending of assets to the recipient device 310. The request of sending assets to the recipient device 310 may thus be based on data values identified in the short-range transfer request 422.

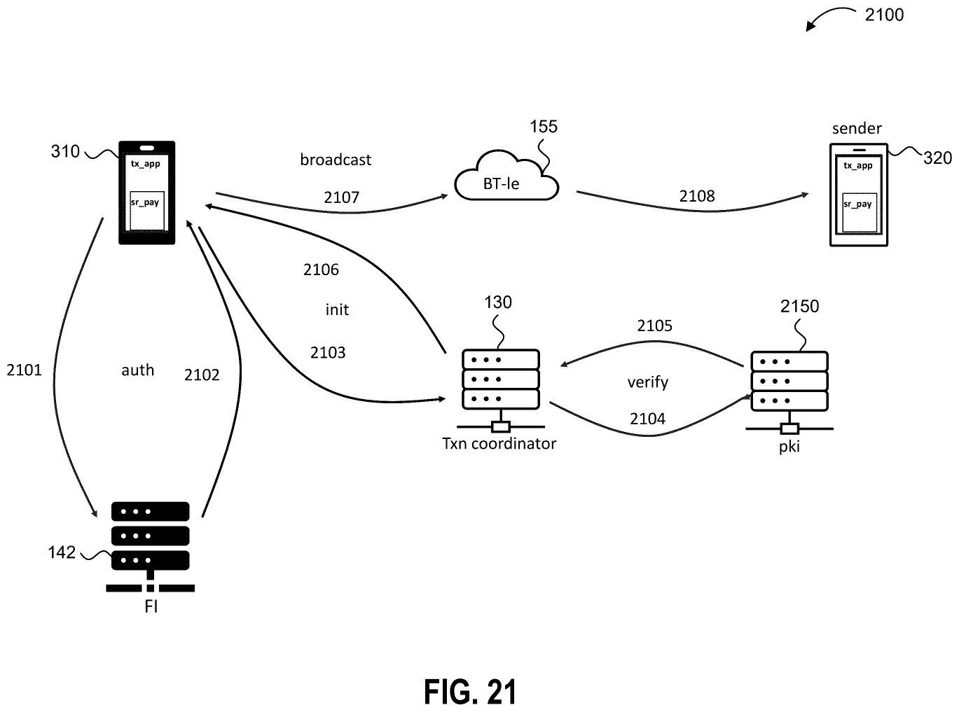

Reference is made to FIG. 21, which illustrates operations of a short-range transfer system 2100 for initialization and discovery of computing devices, in accordance with embodiments of the present disclosure. Reference will be made to prior figures to describe examples of the initialization and discovery operations, in accordance with embodiments of the present disclosure. The recipient device 310, sender device 320, the recipient banking institution system 142 and the transaction coordinator system 130 may include features similar to features described in other examples herein.

The short-range transfer system 2100 may include a public key infrastructure coordinator system 2150 for securely storing public key pairs. As will be described, the public key infrastructure coordinator system 2150 may retrieve public keys associated with an identified recipient banking institution system 142 for decrypting or otherwise unmasking data structures of signed transaction coordinator authentication tokens 390 for operations to validate data values therein.

At operation 2101, the recipient device 310 may transmit a transaction authentication token request 360 to the recipient banking institution system 142. The transaction authentication token request 360 may include a query to provide a transaction coordinator authentication token from the banking institution system 142. The banking institution system 142 may be a banking institution server providing an asset account for the recipient user.

The banking institution system 142 may conduct operations to generate a user transaction identifier and associate the generated user transaction identifier with the recipient user. In some embodiments, the user transaction identifier may be a UUID.

At operation 2102, the banking institution system 142 transmit a signed transaction authentication token 390 to the recipient device 310. The transaction coordinator authentication token may be signed based on a PKI key pair, such as a private key associated with the banking institution system 142.

At operation 2103, the recipient device 310 may transmit the signed transaction coordinator authentication token 390 to the transaction coordinator system 130.

At operation 2104, the transaction coordinator system 130 may transmit a request to the public key infrastructure coordinator system 2150 for retrieving a public key associated with the banking institution system 142.

At operation 2105, the public key infrastructure coordinator system 2150 may transmit the public key to the transaction coordinator system 130, and the transaction coordinator system 130 may conduct operations to decrypt, unmask, or otherwise validate the data values of the signed transaction coordinator authentication token 390 based on the received public key.

The transaction coordinator system 130 may generate a proxy user discovery identifier and associate the proxy user discovery identifier to the given user transaction identifier. In some embodiments, the transaction coordinator system 130 may generate a proxy user discovery identifier based on a seed value determined via a pseudo-random set of operations or functions. In some embodiments, the proxy user discovery identifier may be session specific or ephemeral.

In some scenarios, the proxy user discovery identifier may be generated and used on a session-by-session basis or may be valid on a time-limited basis. The proxy user discovery identifier may not be persistently associated with a given computing device or user to reduce or thwart effects of unscrupulous attempts at proximity user discovery identifier harvesting practices. For example, because proximity user discovery identifiers may be limited in time or limited by time-limited nature of active sessions, an unscrupulous user device conducting operations to conduct data harvesting processes (e.g., detecting proxy user discovery identifiers of proximally located computing devices for unscrupulous purposes) for downstream operations of spoofing or mimicking other devices based on proximity user discovery identifiers may be unsuccessful, as proximity user discovery identifiers may be time-limited in nature.

At operation 2106, transaction coordinator system 130 may generate an initialization data set 392 (FIG. 6), and transmit the initialization data set 392 to the recipient device 310.

The recipient device 310 may generate a transaction discovery packet 394 (FIG. 7) including a type identifier value for indicating that the transaction discovery packet 394 is for initiating a short-range resource transfer operation. The transaction discovery packet 394 may further include an instance or source identifier value for identifying a source of the transaction discovery packet 394. In some embodiments, the instance or source identifier may be a proxy user discovery identifier generated at a prior operation of the transaction coordinator system 130.

At operation 2107, the recipient device 310 may broadcast the generated transaction discovery packet 394 via a short-range network 155, such as Bluetooth™ low energy communication protocols, among other examples. In embodiments where the short-range network 155 may be a Bluetooth™ low energy network, the transaction discovery packet 394 may be generated and transmitted as a Bluetooth™ broadcast discovery frame.

When one or more sender devices 320 are within physical proximity to the recipient device 310, at operation 2108, the one or more sender devices 320 may detect the transaction discovery packet 394 broadcasted by the recipient device 310 for downstream operations of a short-range transfer.

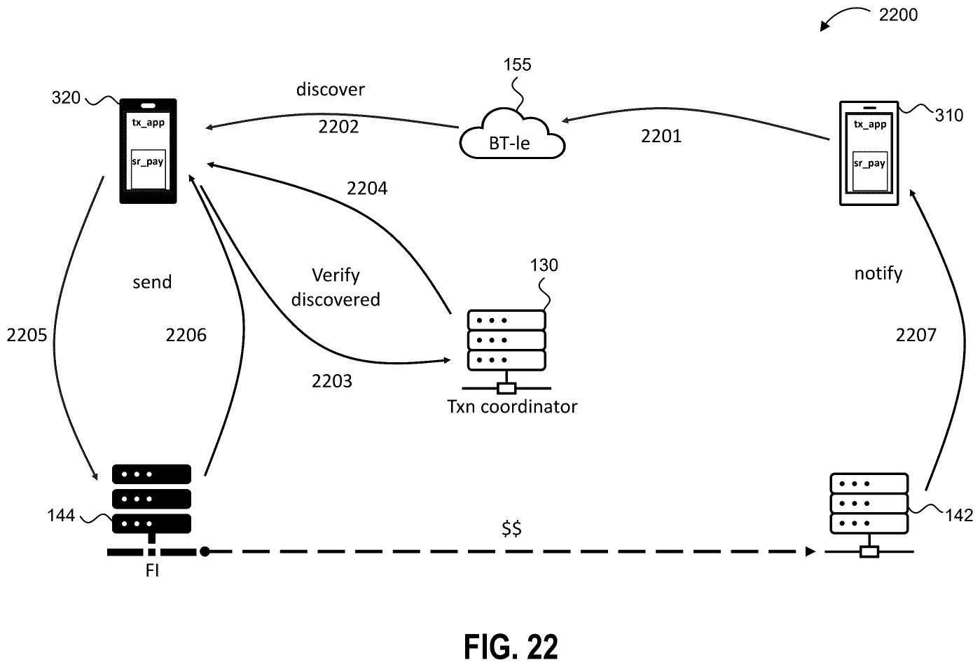

Reference is made to FIG. 22, which illustrates operations of a short-range transfer system 2200 where a sender device 320 is operating as an initiating transfer device for requesting sending of assets to at least one other computing device, in accordance with embodiments of the present disclosure.

In FIG. 22, the recipient device 310 may have conducted operations for initialization for a short-range transfer operation. At operation 2201, the recipient device 310 may conduct operations for broadcasting a transaction discovery packet 394 (FIG. 7) via the short range network 155.

At operation 2202, the sender device 320 may detect or receive the transaction discovery packet 394 broadcasted by the recipient device 310 and generate a user transaction identifier request 396. The user transaction identifier request 396 may be configured for querying the transaction coordinator system 130 for determining or retrieving a user transaction identifier (such as a UUID) associated with the identified proxy user discovery identifier (from the transaction discovery packet 394).

At operation 2203, the recipient device may transmit the user transaction identifier request 396 to the transaction coordinator system 130, and the transaction coordinator system 130 may conduct a data structure look-up from an identifier database 398 (FIG. 8) to retrieve a user transaction identifier associated with the identified proxy user discovery identifier.

As described with reference to examples herein, to conduct such types of one-off electronic transactions whilst reducing the quantity of persistent data or personally identifiable information to be shared among users of computing devices, proxy user discovery identifiers may be discovery session or time-limited in nature. Upon the passage of a time duration, when the proxy user discovery identifier is no longer recognized by the transaction coordinator 130 as a valid identifier, downstream short-range transfers based on such a proxy user discovery identifier may not be allowed.

Accordingly, upon the transaction coordinator system 130 recognizing a proxy user discovery identifier identified from the user transaction identifier request 396, the transaction coordinator system 130 may transmit a user transaction reply 400 (FIG. 10) having at least (i) the user transaction identifier associated with an unexpired proxy user discovery identifier; and (2) an alias identifier such that the sender device 320 may generate downstream short-transfer transaction data sets 406 (FIG. 12) for initiating short-range asset transfers.

At operation 2205, the sender device 320 may generate the short-range transaction data set 406 based on user input, including an indicator of a selected account (e.g., recipient account at the recipient banking institution 142), a user transaction identifier (e.g., UUID) of the user of the recipient device 310, a quantity of assets for transferring to the recipient user, among other data values for carrying out the short-range transaction.

The transaction layer, including the respective banking institution systems 142, 144 may liaise and conduct the asset transfers based on the short-range transaction data set 406. The asset transfer operations may be based on transaction layer implementations, such as the Interac™ e-Transfer platform, real-time rail platforms, or other similar platforms.

At operation 2206 and operation 2207, the sender device 320 and the recipient device 310 may receive a notification message that the short-range transfer is complete.

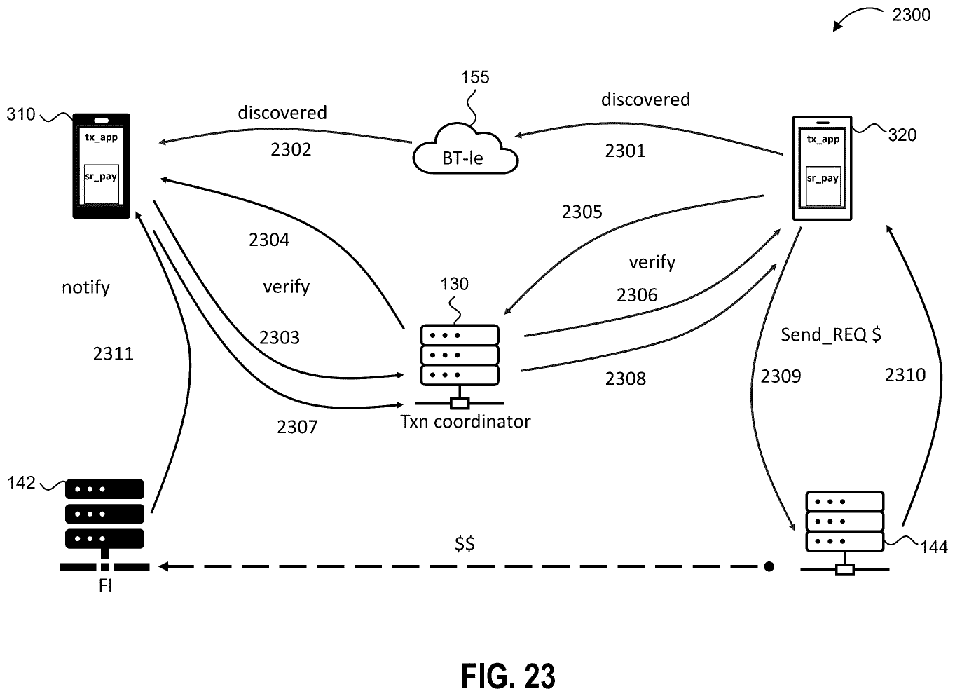

Reference is made to FIG. 23, which illustrates operations of a short-range transfer system 2300 where a recipient device 310 may be operating as an initiating transfer device for requesting receipt of assets from at least one other computing device, such as a sender device 320, in accordance with embodiments of the present disclosure.

In the example of FIG. 23, the recipient device 310 and the sender device 320 may have conducted operations for initialization for short-range transfer operations.

At operation 2301 and operation 2302, the respective recipient device 310 and the sender device 320 may conduct operations for broadcasting transaction discovery packets 394 (FIG. 7). For example, where the short-range network 155 may be a Bluetooth™ low energy network, the transaction discovery packet 394 may be generated and transmitted as Bluetooth™ broadcast discovery frames.

The respective computing devices may transmit user transaction identifier requests 396 (FIG. 8) to the transaction coordinator system 130 and may receive user transaction reply 400 (FIG. 9) for verifying that respective proxy user discovery identifiers continue to be timely and valid.

For example, the recipient device 310 may be configured with operation 2303 and operation 2304 for verifying that identified proxy user discovery identifiers extracted from detected transaction discovery packets 394 continue to be timely and valid. In this example, the detected transaction discovery packets 394 may be associated with the sender device 320.

The sender device 320 may be configured with operation 2305 and operation 2306 for verifying that identified proxy user discovery identifiers extracted from detected transaction discovery packets 294 continue to be timely and valid. In this example, the detected transaction discovery packets 394 may be associated with the recipient device 310.

In some embodiments, operations for verifying that the identified proxy user discovery identifiers continue to be timely and valid include operations at the transaction coordinator 130 for providing alias identifiers for display at respective computing devices, as described in some embodiments of the present disclosure.

For example, from the recipient device 310 perspective, the timely and valid alias identifiers may be configured to allow a recipient user to identify sender devices 320 towards which asset transfer requests can be made.

In another example, from the sender device 320 perspective, the timely and valid alias identifiers may be configured to allow a sender user to identify recipient devices 310 that assets should be transferred to.

Upon the respective devices conducting operations for verifying that identified proxy user discovery identifiers continue to be timely and valid for short-range transfer operations, the recipient device 310 at operation 2307 may transmit, to the transaction coordinator system 130 a short-range transfer request 422 (FIG. 17) for initiating asset transfers at the transaction layer.

At operation 2308, the transaction coordinator system 2308 may transmit a transfer request based on the short-range transfer request 422 to the sender device 320.

At operation 2309, the sender device 320 may generate a short-range transaction data set 406 including a combination of data values necessary for effecting the transaction as between banking institution systems 142, 144 at a transaction layer, as described in some embodiments of the present disclosure.

Upon completion of the transaction as between the banking institution systems 142, 144, at operation 2310 and operation 2311, the respective banking institution systems 142, 144 may transmit notification messages to the recipient device 310 and the sender device 310 that the requested short-range transfer operations are completed.

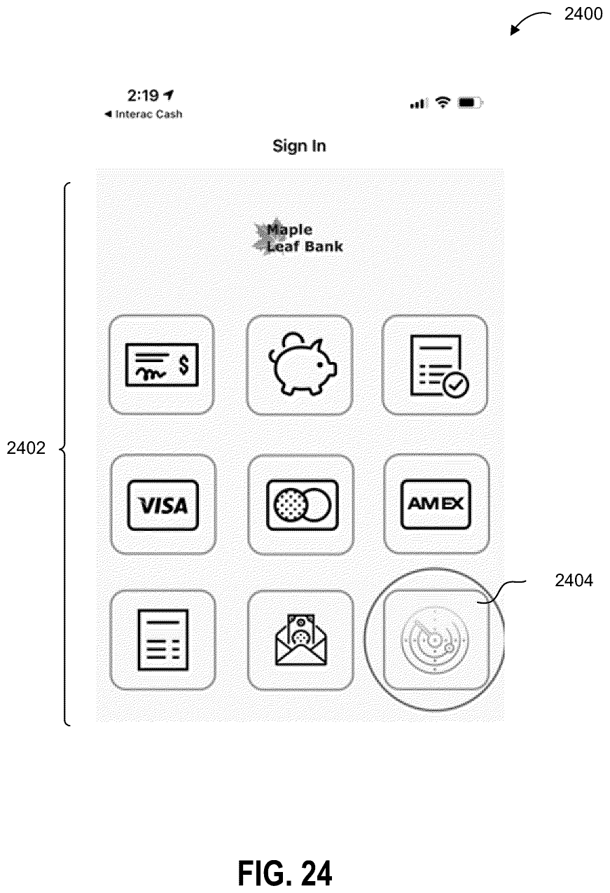

Reference is made to FIG. 24, which illustrates a user interface 2400 associated with the transaction application 206a (FIG. 2), in accordance with embodiments of the present disclosure.

The user interface 2400 may include one or more user interface elements 2402 configured to allow a user to conduct operations for managing assets associated with a user account.

In response to receiving input at a short-range transfer application element 2404, the short-range transfer application 206b may be invoked, and operations of a short-range transfer described herein may be executed.

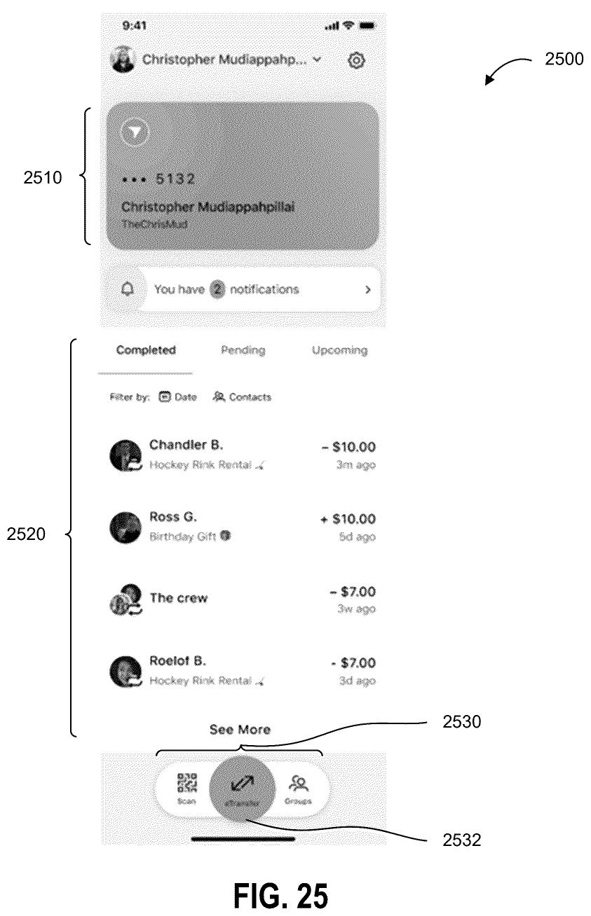

Reference is made to FIG. 25, which illustrates a user interface 2500 associated with the short-range transfer application 206b (FIG. 2), in accordance with embodiments of the present disclosure.

The user interface 2500 includes a display region 2510 providing an indication representing a user resource account. The graphical user interface 2500 may include a transfer tracking region 2520 for displaying pending, prior completed, or future scheduled resource transfers associated with the user resource account.

The graphical user interface 2500 may include configuration icons 2530 for initiating operations of the methods described herein. In some embodiments, the configuration icons 2530 include an initialize e-Transfer icon 2532 for initiating a resource transfer (e.g., “e-Transfer”) or for requesting a resource transfer. In some scenarios, a recipient device may wish to request a resource transfer, thereby generating broadcast signals representing a proximity identifier for one or more sender devices to detect. One or more sender devices may detect a proxy user discovery identifier associated with a recipient device and generate a short-range transfer request 422 (FIG. 17) for a downstream short-range transfer.

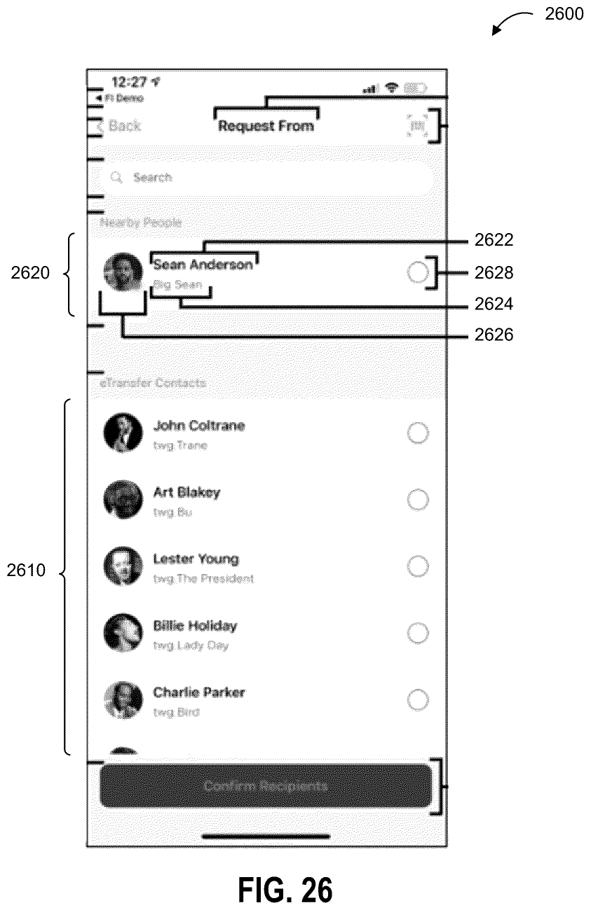

Reference is made to FIG. 26, which illustrates a user interface 2600 associated with the short-range transfer application 206b (FIG. 2), in accordance with embodiments of the present disclosure.

The user interface 2600 includes a display region 2610 including an example listing of prior-identified recipient users for resource transfers. The example listing of recipient users may have been saved from past operations, and may represent a listing of known recipient users that the buyer user may anticipate conducting future or recurring resource transfers with.

The user interface 2600 includes a nearby recipient display region 2620 including alias identifiers of users associated with computing devices within a proximal region. The alias identifiers may include a name field 2622, a proximity transfer alias field 2624, or a representative image field 2626 associated with a user of the nearby computing device. Further, the nearby recipient display region 2620 may include a selectable input region 2628 allowing a user to select that particular recipient user for a downstream short-range transfer.

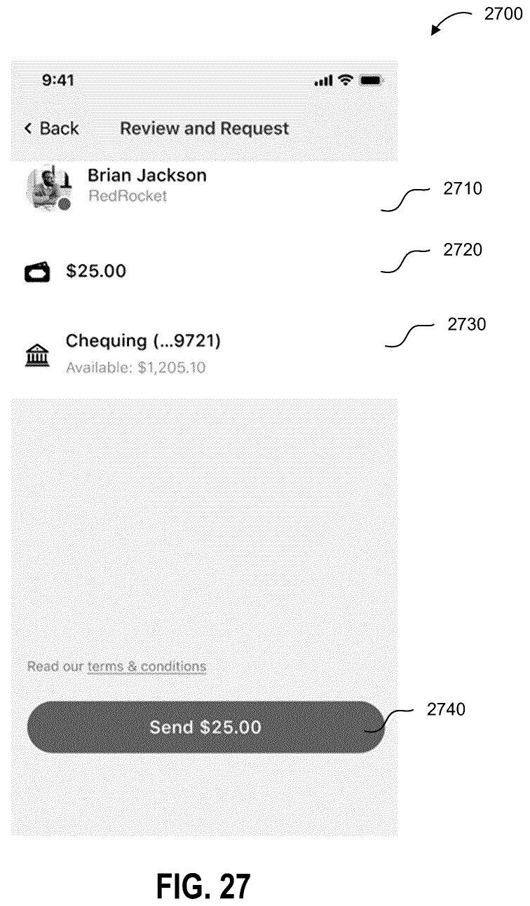

Reference is made to FIG. 27, which illustrates a user interface 2700 associated with the short-range transfer application 206b (FIG. 2), in accordance with embodiments of the present disclosure.

The user interface 2700 may include a display region 2710 including target recipient user details. The graphical user interface 2700 may include a display region 2720 for receiving user input representing a quantity of resources for the target short-range transfer. The graphical user interface 2700 may also include a display region 2730 for receiving user input representing a user account from which the quantity of resources may be drawn from (if transmitting a transfer) or deposited to (if receiving a transfer).

Upon the user confirming the short-range transfer details, the graphical user interface 2700 may include a user input element 2740 for receiving confirmation that the requested short-range transfer details are accurate.

In some embodiments, proxy user discovery identifiers may be configured as graphical indicia displayed on physical or electronic medium. In some scenarios, a recipient user may display the graphical indicia at a recipient device or via physical signage, such that a sender device may initiate a short-range resource transfer based on the proxy user discovery identifier in graphical form. In some embodiments, a sender device may include an image capture device for generating image data.

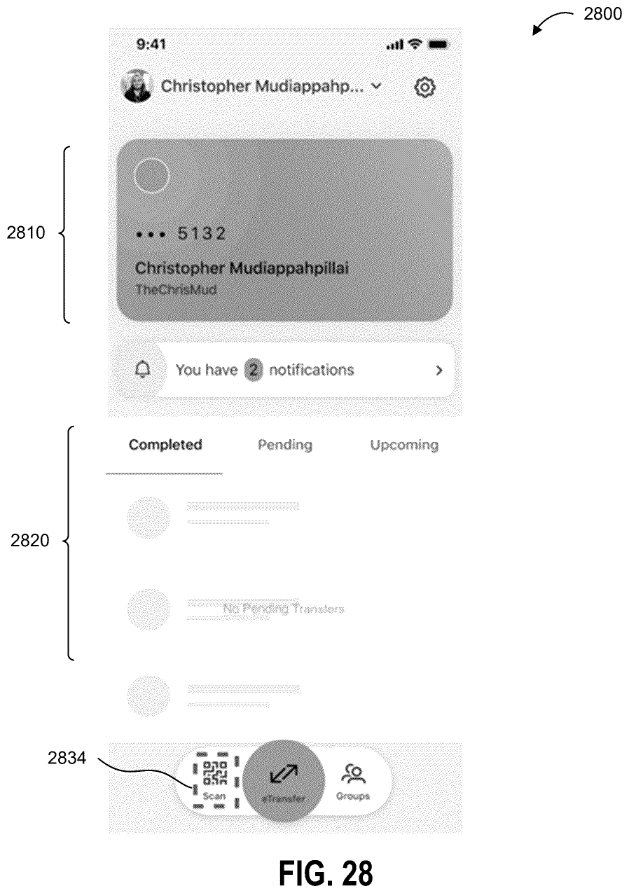

Reference is made to FIG. 28, which illustrates a user interface 2800 associated with the short-range transfer application 206b (FIG. 2), in accordance with embodiments of the present disclosure. The user interface 2800 may include features similar to the user interface 2500 of FIG. 25.

For example, the user interface 2800 may include a display region 2810 providing an indication representing a user resource account. The graphical user interface 2800 may include a transfer tracking region 2820 for displaying pending, prior completed, or future scheduled resource transfers associated with the user resource account.

The user interface 2800 may include a proximity scan icon 2834 for receiving input from a user to initialize a proximity resource transfer operation based on a graphical indicial or a near field communication (NFC) tag.

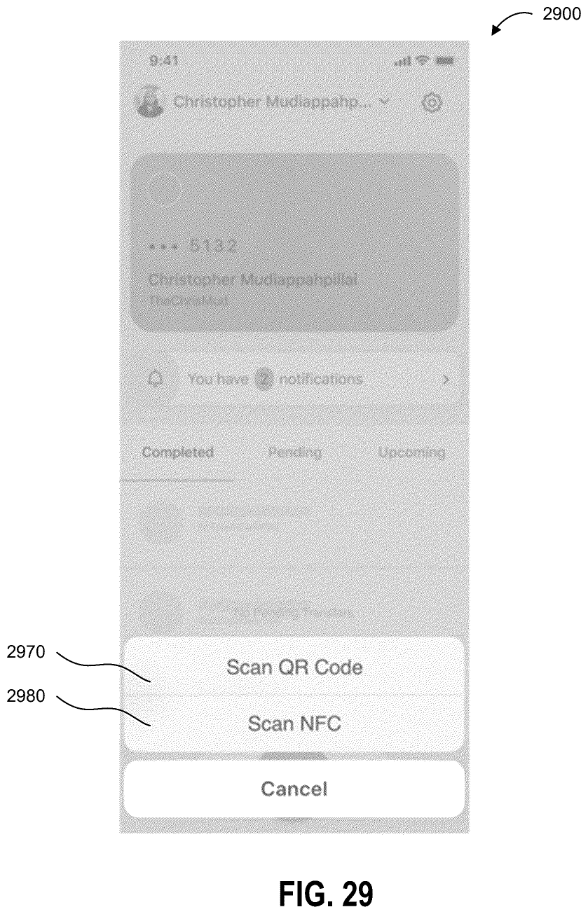

For example, in FIG. 29, once a sender device receives input at the proximity scan icon 2834, the sender device may provide potions for scanning a QR code (graphical indicia) 2970 or for scanning a NFC tag 2980.

In some embodiments, the sender device may provide a substantially real-time user interface having an image capture device viewfinder to obtain an image of graphical indicia associated with a proxy user discovery identifier.

To decode the proxy user discovery identifier, the sender device may transmit the image data or decoded data to the transaction coordinator system 130 (FIG. 1) for deciphering the decoded data set and for generating a user transaction reply 400 (FIG. 9).

In embodiments where the sender device may be conducting NFC operations to detect proxy user discovery identifiers associated with other computing devices, the sender device may conduct NFC detection operations while proximate a NFC tag associated with other computing devices.

To decode data encoded by received NFC broadcast signals, the sender device may transmit the decoded NFC signal to the transaction coordinator system 130 for deciphering and for generating a user transaction reply 400 (FIG. 9).

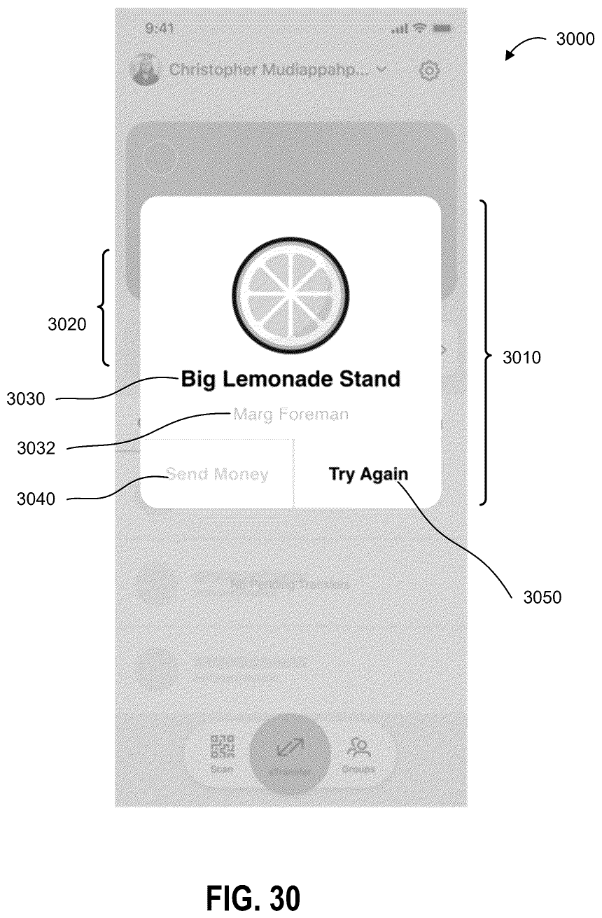

Reference is made to FIG. 30, which illustrates a user interface 3000 associated with the short-range transfer application 206b (FIG. 2), in accordance with embodiments of the present disclosure.

The user interface 3000 may be an example interface for confirming data values associated with a proposed short-range transfer prior to generating the short-range transaction data set 406 (FIG. 12). For example, the user interface 3000 may include alias identifiers 3010, including representative photo 3020, a pseudonym 3030, or a user name 3032 associated with a recipient device.

In some embodiments, user interface 3000 may include a confirmation user interface element 3040, such as a ‘send money’ user interface element, for receiving user input to confirm a proposed short-range transfer.

In some embodiments, the user interface 3000 may include a user interface element 3050 (e.g., text noting “Try Again”) for re-initializing operations to re-obtain image data associated with a graphical indicia or for re-initializing operations for re-scanning an NFC tag. In some scenarios, it may be desirable to re-initialize operations for re-obtaining image data associated with a graphical indicia or for re-initializing operations for re-scanning an NFC tag in environments where there may be more than one potential recipient device.

In some scenarios, configuration of proxy user discovery identifiers may be mapped with user transaction identifiers, such as UUIDs, based on one or more personal personas for downstream short-range transfer operations.

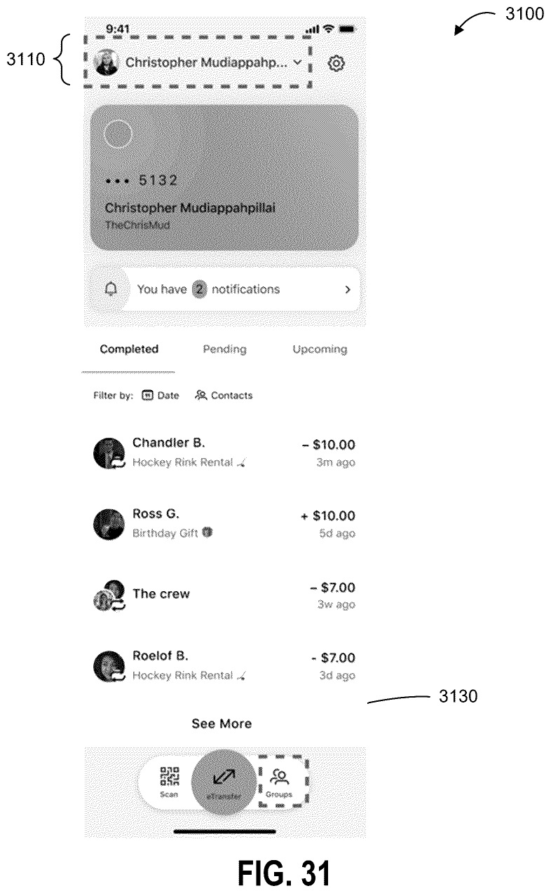

Reference is made to FIG. 31, which illustrates a user interface 3100 associated with the short-range transfer application 206b (FIG. 2), in accordance with embodiments of the present disclosure. The user interface 3100 may be similar to the user interface 2500 illustrated in FIG. 25, including configuration icons 3130 for initiating operations of the methods described herein.

In some embodiments, the graphical user interface 3100 may include a persona menu interface element 3110 for displaying a currently selected persona alias. In the present illustration, the persona alias may be a persona associated with an individual user named “Christopher”.

In some scenarios, the user may be a business owner and may wish to present an alias on behalf of an organization (e.g., company organization) whilst receiving resource transfers into a sole or common resource account. For example, Christopher may be a small business owner who operates under a sole proprietorship business structure. Christopher may utilize a resource account for both personal and company resource transactions. To maintain an outward presence as a company organization, it may be desirable for Christopher to dynamically alter the displayed persona alias associated with a broadcasted proximity identifier associated with Christopher.

In some embodiments, the user (e.g., Christopher) may provide input at the persona menu interface element 3110 for dynamically altering an outward persona to sender devices.

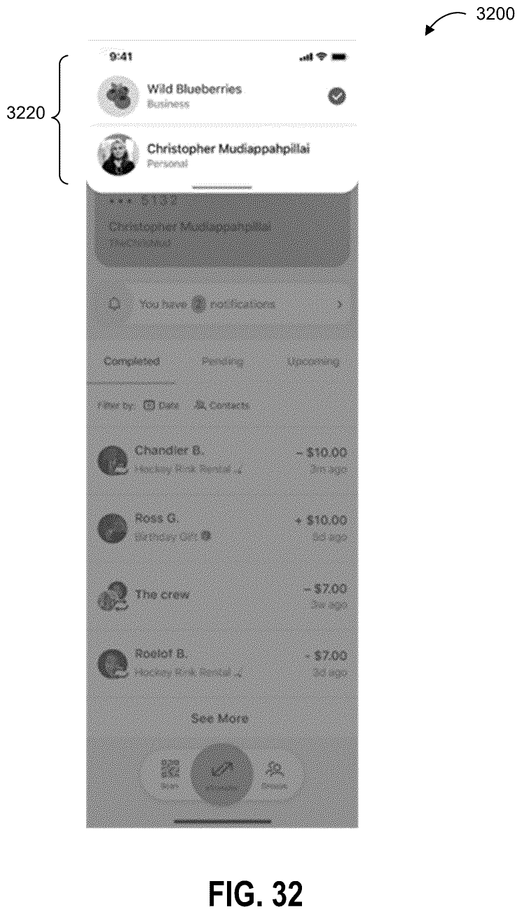

FIG. 32 shows a user interface 3200 generated by the short-range transfer application 206b (FIG. 2), in accordance with embodiments of the present disclosure. The short-range transfer application 206b may be configured to include instructions for displaying a dynamic toggle menu 3220 for altering an outward persona to sender devices,

In FIG. 32, the recipient user (e.g., Christopher) may dynamically alter the outward persona by selecting the optional alternate persona alias entitled “Wild Blueberries”.

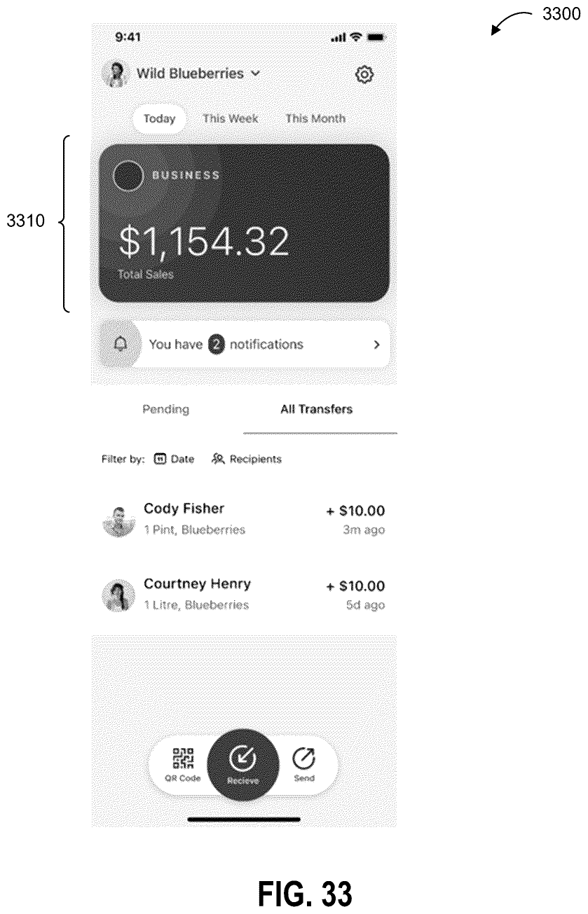

FIG. 33 shows a user interface 3300 associated with the short-range transfer application 206b (FIG. 2), in accordance with embodiments of the present disclosure. The short-range transfer application 206b may be configured to include instructions for displaying an updated user interface for managing and requesting short-range transfers. Following selection from the dynamic toggle menu 3220 (FIG. 32) for altering an outward persona associated with the recipient user, the display region 3310 may provide an indication representing the recipient user's resource account, with an indication that the resource account may be setup to receive resource transfers in an outward business persona mode.

In some embodiments, an individual user persona alias may be mapped to a user banking account (or other asset account) that is different than a user banking account mapped to a business persona alias. Thus, in some embodiments, proxy user discovery identifiers associated with persona aliases may be associated with a user transaction identifier (e.g., UUID associated with a user and a specific user asset account) that may be different than a user transaction identifier of a business persona.

In some other embodiments, an individual user persona alias and a business personal alias may be mapped to the same banking (or asset) account. Accordingly, a sender user may maintain separate outward personas.

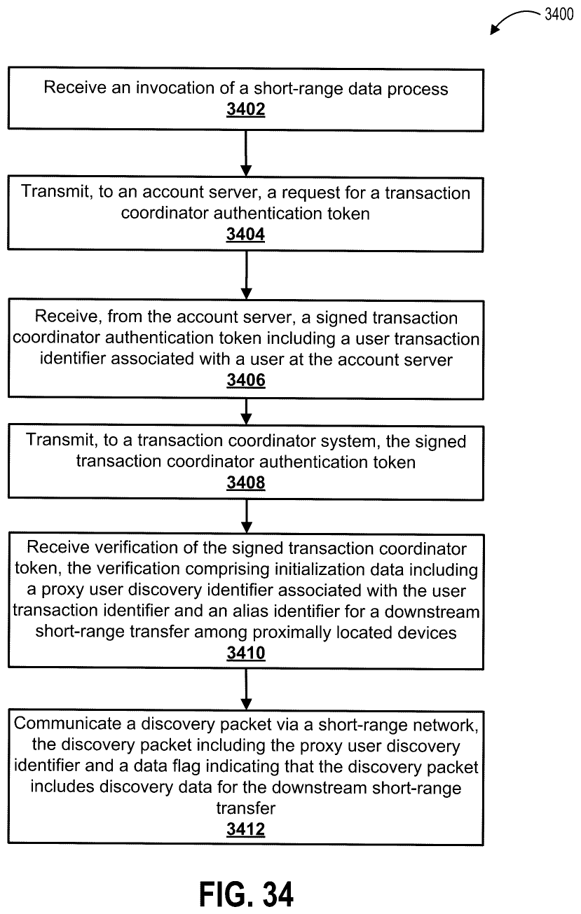

Reference is made to FIG. 34, which illustrates a flowchart of a method 3400 of short-range data processes, in accordance with embodiments of the present disclosure. In some embodiments, short-range data processes may include short-range electronic payment transfer processes described in the present disclosure.

The method 3400 may be conducted by a processor of a computing device, such as the computing device 200 illustrated in FIG. 2. Processor-readable instructions may be stored in the memory 206 and may be associated with the transaction application 206a, the short-range transfer application 206b, or other processor-readable applications not illustrated in FIG. 2. The method 3400 may include operations, such as data retrievals, data manipulations, data storage, or the like, and may include other computer executable operations.

In some scenarios, it may be desirable to generate short-range transfer requests without a requirement to exchange identifiers that may be generally considered personally identifiable information. For instance, in scenarios where users may wish to conduct one-off resource transfers (e.g., akin to cash payments) with no contemplated future resource transfer relationship, the sender and recipient users may prefer to not share identifiers that may be generally considered personally identifiable information. One-off resource transfers may be desirable to retail marketplaces, such as farmers' marketplaces, in situations where vendors provide non-recurring services, or in situations where acquaintances may wish to share costs on goods or services.

The method 3400 may be conducted by a computing device wishing to conduct electronic payment transactions, whether as a recipient device or a sender device, based on embodiments of the short-range transfer system disclosed herein.

In some scenarios where user transaction identifiers associated with user accounts may be persistently defined, unscrupulous users may be inclined to conduct data harvesting-type operations to detect numerous proxy user discovery identifiers and subsequently attempt to deceive a sender user in transferring resources to the unscrupulous user.

To address unintended effects of unscrupulous user operations, embodiments of the short-range transfer system described herein may generate session-limited or time-limited proxy user discovery identifiers, thereby reducing or thwarting proximity identifier data harvesting practices for promulgating unintended resource transfers.

The method 3400 may include operations associated with initialization or discovery of computing devices 200. In some embodiments, the computing device 200 may be configured as a broadcasting device or a discovery device depending on a mode of operation. For example, any one of a broadcasting device and a discovery device may initiate short-range transfer operations with one or more other devices and thereby become an initiating transfer device.

At operation 3402, the processor may receive an invocation of a short-range data process. For example, referring to FIG. 24, the processor may receive an input at a short-range transfer application element 2404 for initializing example short-range payment transfer data processes.

At operation 3404, the processor may transmit, to an account server, a request for a transaction coordinator authentication token. For example, referring to FIG. 3, the processor may transmit a request 360 including a query to provide a transaction coordinator authentication token from a banking institution server. The banking institution server may provide a user account for a given user.

In some embodiments, the transaction coordinator authentication token may include a resource system identifier and a bank application user identifier (see e.g., FIG. 4). The bank application user identifier may be a user transaction identifier, such as a universal unique identifier associated with a user account.

At operation 3406, the processor may receive, from the account server, a signed transaction coordinator authentication token. The signed transaction coordinator authentication token may be signed based on a private key of a private key infrastructure (PKI) key pair.

At operation 3408, the processor may transmit, to a transaction coordinator system 130 (FIG. 1), the signed transaction coordinator authentication token. As described herein, in some embodiments, the transaction coordinator system 130 may be configured to conduct operations of associating user transaction identifiers with generated proxy user discovery identifiers for downstream short-range payment transaction data processes.

At operation 3410, the processor may receive verification of the signed transaction coordinator token. The received verification may comprise initialization data set 392 (FIG. 6). The initialization data set 392 may include a proxy user discovery identifier associated with the user transaction identifier and an alias identifier for a downstream short-range transfer among proximally located devices.

In some embodiments, the alias identifier may include at least one of a pseudonym, a representative photo, or other user names for display at any one of the proximally located computing devices.

At operation 3412, the processor may communicate a discovery packet 394 (FIG. 7) via a short-range network 155 (FIG. 1). The discovery packet 394 may include a type identifier or data flag indicating that the discovery packet 394 includes discovery data for downstream short-range transfer data operations and a proxy user discovery identifier.

In some embodiments, the proxy user discovery identifier may be configured to be valid on at least one of a discovery session-by-session basis or a time-duration limited basis. In some embodiments, the user transaction identifier may be a persistent identifier generated by the account server.

Upon communicating or broadcasting the discovery packet 394 via the short-range network 155, one or more other computing devices may detect the communicated discovery packet for downstream short-range transfer data operations.

In scenarios where a sender device detects the communicated discovery packet 394 (e.g., as an inbound discovery packet), that sender device may conduct operations for verifying the proxy user discovery identifier by transmitting queries to the transaction coordinator system 130, and subsequently generating short-range transaction data sets including data values for effecting a payment transfer or other asset transfer operations.

In scenarios where a recipient device detects a communicated discovery packet 394 (e.g., as an inbound discovery packet), that recipient device may conduct operations for verifying the proxy user discovery identifier of a prospective sender device by transmitting queries to the transaction coordinator system 130, and subsequently generating a short-range transfer request to the transaction coordinator system 130 for initiating short-range transfer data operations.

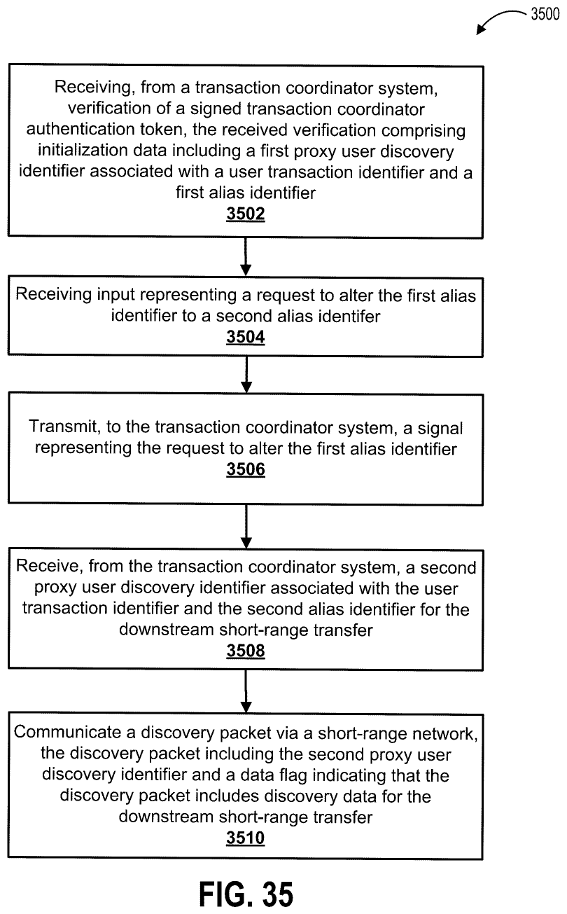

Reference is made to FIG. 35, which illustrates a flowchart of a method 3500 of short-range data processes, in accordance with embodiments of the present disclosure. In some embodiments, short-range data processes may include short-range electronic payment transfer processes described in the present disclosure.

The method 3500 may be conducted by a processor of a computing device, such as the computing device 200 illustrated in FIG. 2. Processor-readable instructions may be stored in the memory 206 and may be associated with the transaction application 206a, the short-range transfer application 206b, or other processor-readable applications not illustrated in FIG. 2. The method 3500 may include operations, such as data retrievals, data manipulations, data storage, or the like, and may include other computer executable operations. Operations of the method 3500 may be included in operations associated with initialization or discovery of computing devices 200.

At operation 3502, the processor may receive verification of the signed transaction coordinator token. The received verification may comprise initialization data set 392 (FIG. 6). The initialization data set 392 may include a first proxy user discovery identifier associated with the user transaction identifier and a first alias identifier for a downstream short-range transfer among proximally located devices.

As an example, referring to FIG. 31, the first alias identifier may be “Christopher” representing the user in as a single user capacity.

At operation 3504, the processor may receive input representing a request to alter the first alias identifier to a second alias identifier. Referring to FIG. 32, based on a user interface displayed at a display device, the processor may receive input to alter the alias identifier from “Christopher” to a second alias identifier of “Wild Blueberries”.

At operation 3506, the processor may transmit, to the transaction coordinator system 130 (FIG. 1) a signal representing the request to alter the first alias identifier.

At operation 3508, the processor may receive, from the transaction coordinator system 130, a second proxy user discovery identifier associated with the user transaction identifier and the second alias identifier for the downstream short-range transfer data process.

In some embodiments, the user transaction identifier is a common identifier associated with the first proxy user discovery identifier and the second proxy user discovery identifier. As the user transaction identifier (such as a UUID) described herein may be associated with a particular user account at a banking institution system, the various alias identifiers may be associated with a common user account or banking account.

In the present example, the second proxy user discovery identifier may be associated with a different persona.

At operation 3510, the processor may communicate a discovery packet via a short-range network, the discovery packet including the second proxy user discovery identifier and a data flag indicating that the discovery packet includes discovery data for the downstream short-range transfer.

As an example, the discovery packet including the second proxy user discovery identifier may be associated with the altered persona. For example, referring to FIG. 33, the second proxy user discovery identifier may be associated with a user's business account persona for downstream short-range transfer data operations.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

What is claimed is:

1. A method comprising:
receiving, from a transaction coordinator system, verification of a signed transaction coordinator authentication token, the received verification comprising initialization data including a first proxy user discovery identifier associated with a user transaction identifier and a first alias identifier for a downstream short-range transfer data process among proximally located devices;
receiving input representing a request to alter the first alias identifier to a second alias identifier;
transmitting, to the transaction coordinator system, a signal representing the request to alter the first alias identifier;
receiving, from the transaction coordinator system, a second proxy user discovery identifier associated with the user transaction identifier and the second alias identifier for the downstream short-range transfer data process; and
communicating a discovery packet via a short-range network, the discovery packet including the second proxy user discovery identifier and a data flag indicating that the discovery packet includes discovery data for the downstream short-range transfer.

2. The method of claim 1, wherein the user transaction identifier is a common identifier associated with the first proxy user discovery identifier and the second proxy user discovery identifier.

3. The method of claim 1, wherein the association of the first user discovery identifier or the second user discovery identifier with the user transaction identifier is valid on a session-by-session basis or on a time duration basis.

4. The method of claim 3, wherein the time duration basis is based on pendency of the recipient device maintaining a session with the transaction coordinator system.

5. The method of claim 1, wherein the respective first alias identifier and the second alias identifier include display of at least one of a pseudonym associated with a user of the device or a representative image associated with the user.

6. The method of claim 1, wherein the first proxy user discovery identifier and the second proxy user discovery identifier is mapped based on a data structure, at the transaction coordinator system, to the user transaction identifier.

7. The method of claim 1, wherein the user transaction identifier is a persistent identifier generated by an account server.

8. The method of claim 1, wherein the short-range network includes a Bluetooth™ low energy network or a near field communication network.

9. The method of claim 1, wherein the short-range network includes a Bluetooth™ low energy network, and the method further comprising determining a Bluetooth™ transmitter sensitivity setting value associated with communicating the discovery packet via the short-range network.

10. A device comprising:
a communication circuit;
a processor coupled to the communication circuit; and
a memory coupled to the processor and storing processor-executable instructions that, when executed, configure the processor to:
receive, from a transaction coordinator system, verification of a signed transaction coordinator authentication token, the received verification comprising initialization data including a first proxy user discovery identifier associated with a user transaction identifier and a first alias identifier for a downstream short-range transfer data process among proximally located devices;
receive input representing a request to alter the first alias identifier to a second alias identifier;
transmit, to the transaction coordinator system, a signal representing the request to alter the first alias identifier;
receive, from the transaction coordinator system, a second proxy user discovery identifier associated with the user transaction identifier and the second alias identifier for the downstream short-range transfer data process; and
communicate a discovery packet via a short-range network, the discovery packet including the second proxy user discovery identifier and a data flag indicating that the discovery packet includes discovery data for the downstream short-range transfer.

11. The device of claim 10, wherein the user transaction identifier is a common identifier associated with the first proxy user discovery identifier and the second proxy user discovery identifier.

12. The device of claim 10, wherein the association of the first user discovery identifier or the second user discovery identifier with the user transaction identifier is valid on a session-by-session basis or on a time duration basis.

13. The device of claim 12, wherein the time duration basis is based on pendency of the recipient device maintaining a session with the transaction coordinator system.

14. The device of claim 10, wherein the respective first alias identifier and the second alias identifier include display of at least one of a pseudonym associated with a user of the device or a representative image associated with the user.

15. The device of claim 10, wherein the first proxy user discovery identifier and the second proxy user discovery identifier is mapped based on a data structure, at the transaction coordinator system, to the user transaction identifier.

16. The device of claim 10, wherein the user transaction identifier is a persistent identifier generated by an account server.

17. The device of claim 10, wherein the short-range network includes a Bluetooth™ low energy network or a near field communication network.

18. The device of claim 10, wherein the communication circuit includes a combination of a short-range network for at least one of broadcasting or detecting one or more discovery packets and a communication network transmitting the short-range transaction data set to a transaction layer, wherein the communication network is discrete from the short-range network.

19. The device of claim 10, wherein the short-range network includes a Bluetooth™ low energy network, and the method further comprising determining a Bluetooth™ transmitter sensitivity setting value associated with communicating the discovery packet via the short-range network.

20. A non-transitory computer-readable medium or media having stored thereon machine interpretable instructions which, when executed by a processor, cause the processor to perform a computer-implemented method, the method comprising:
receiving, from a transaction coordinator system, verification of a signed transaction coordinator authentication token, the received verification comprising initialization data including a first proxy user discovery identifier associated with a user transaction identifier and a first alias identifier for a downstream short-range transfer data process among proximally located devices;
receiving input representing a request to alter the first alias identifier to a second alias identifier;
transmitting, to the transaction coordinator system, a signal representing the request to alter the first alias identifier;
receiving, from the transaction coordinator system, a second proxy user discovery identifier associated with the user transaction identifier and the second alias identifier for the downstream short-range transfer data process; and
communicating a discovery packet via a short-range network, the discovery packet including the second proxy user discovery identifier and a data flag indicating that the discovery packet includes discovery data for the downstream short-range transfer.
